(19) United States
(12) Patent Application Publication
(10) Pub. No.: US 2009/0043650 A1
(43) Pub. Date: Feb. 12, 2009

(54) Segmented services having a global structure of networked independent entities

(75) Inventors: Raj Vasant Abhyanker, Cupertino, CA (US); Babar Rana, East Palo Alto, CA (US); Nilay Shah, Gujarat (IN)

Correspondence Address: Raj Abhyanker, LLP;c/o Intellevate, P.O. Box 52050, Minneapolis, MN, 55402, US

(73) Assignee: LegalForce, Inc.

(21) Appl. No.: 11/891,072

(22) Filed: Aug. 8, 2007

(51) Int. Cl. G06Q 50/00

(52) U.S. Cl. 705/14; 705/1; 705/35

(57) ABSTRACT

A method, apparatus and system of segmented services having a global structure of networked independent entities are disclosed. In one embodiment, a method of a network of patent attorneys includes providing a holistic patent services support solution to a patent attorney forming a separate entity, permitting the separate entity to adopt a trade identity different than that of the network of patent attorneys, and performing a core portion of a patent legal service through the separate entity of the patent attorney. The method may include transferring a relationship between the patent attorney and a client to the network of the patent attorneys, and marketing a corporate ownership interest of the network of patent attorneys to parties other than members of a State Bar Association to which the patent attorney belongs without violating a regulation of the State Bar Association when the core portion is performed through the separate entity.

### FIELD OF TECHNOLOGY

This disclosure relates generally to an enterprise method, a technical field of software and/or hardware technology; and, in one example embodiment, to a method, an apparatus, and a system of segmented services having a global structure of networked independent entities.

### BACKGROUND

An experienced professional (e.g., an attorney, a consultant, a doctor, an accountant, an architect etc.) may provide a service (e.g., a legal service, a consulting service, a medical service, an accounting service, an architecture service, etc.) through a services entity (e.g., a law firm, a consulting firm, a private practice, etc.). The experienced professional may be subjected to a regulation of his/her conduct (e.g., unauthorized practice of law, preserving client confidences, export restrictions, equities held, etc.) that may be governed by a trade agency (e.g., a State Bar Association) and/or a government entity (e.g., a Department of Commerce).

The experienced professional (e.g., an associate of the law firm, a mid-level partner at the law firm, etc.) may be limited (e.g., through the regulation) in attracting a new client to the services entity (e.g., the law firm) because of a pre-existing relationship between a senior professional of the services entity (e.g., a senior partner of the law firm) and a retained client. The pre-existing relationship may create conflict of interest between the services entity and the new client under the regulation (e.g., even when the experienced professional may not be directly involved with work of the retained client).

In addition, a budget constraint (e.g., a fixed fee) of the retained client may force the experienced professional to take a short-cut (e.g., an audio dictation) that may lower a quality of the service when performing a core portion (e.g., writing a set of claims, architecting figures, etc.) and/or a task portion (e.g., writing a detailed description, formalizing drawings, proofreading, writing a summary, writing a background, writing an abstract, prior art analysis, etc.). In addition, the retained client may be dissatisfied with a periodic increase (e.g., an annual increase) of a billing rate, a high overhead structure of the services entity, and/or with a performance of the task portion by the experienced professional charging the retained client at a high billing rate.

Furthermore, the experienced professional may not enjoy performing the task portion (e.g., may not fully utilize the creative talents, education, and/or skills of the experienced professional). The experienced professional may be subjected to billing pressures (e.g., 2,000 billable hours per year) at high billing rate (e.g., $350/hour) to progress in the services entity. A percentage of the high billing rate of the experienced professional may be allocated as profit to the senior professional and/or to other senior professionals (e.g., 33% of the billing rate).

The experienced professional may be dissatisfied with a compensation level and/or a structural career constraint (e.g., because of the conflict of interest) when the experienced professional has a talent that may be directly appreciated by the new client, the retained client, and/or other clients. The experienced professional may not have a patience to wait many years (e.g., 20 years) until a departure (e.g., a resignation, a retirement, a death, a transfer, etc.) of the senior professional and/or the retained client before earning an equitable portion of the profits of the billing rate.

As an alternative, the experienced professional may not have a confidence, a bandwidth, and/or a skill to manage a host of issues when starting an independent services entity (e.g., corporate formation, billing, paralegal support, docketing, accounting, taxes, payroll, cash flow, etc.). Therefore, the experienced professional may be denied an opportunity to realize his/her potential.

### SUMMARY

A method, apparatus and system of segmented services having a global structure of networked independent entities are disclosed. In one aspect, a method of a network of patent attorneys includes providing a holistic patent services support solution to a patent attorney (e.g., may be recruited from an external network when the patent attorney has an independent client base above a threshold value) forming a separate entity, permitting the separate entity to adopt a trade identity different than that of the network of patent attorneys and performing a core portion of a patent legal service through the separate entity of the patent attorney.

In addition, providing the holistic patent services support solution may include segmenting a task portion of a professional service from the core portion of the patent legal service based on a skill level required to perform the task portion and the core portion and improving a quality benchmark of the task portion of the patent legal service by performing the task portion in a foreign jurisdiction entity where a foreign labor rate permits the task portion to be dedicated additional time in a given budget.

The method may further include transferring a relationship between the patent attorney and a client to the network of the patent attorneys, and marketing a corporate ownership interest of the network of patent attorneys to parties other than members of a State Bar Association to which the patent attorney belongs without violating a regulation of the State Bar Association when the core portion is performed through the separate entity, a separate entity ownership interest may be owned entirely by the members of the State Bar Association.

The method may also include providing the corporate ownership interest as stock options to the patent attorney based on an origination revenue, an objective quality-benchmark of work product, a tenure, and a client feedback rating of the patent attorney. In addition, the method may include selecting a foreign jurisdiction based on a writing skill profile, an education profile, an infrastructural profile, a judicial precedent profile, a political profile, a labor cost profile, a language proficiency profile, an economic profile, a cultural profile, and a special expertise profile.

The method may further include training employees of the foreign jurisdiction entity through a uniform best practice per technology area methodology developed by an advisory board of recognized experts in a field of patent law, providing an internal quality control team of the network of patent attorneys to monitor and manage adherence to the uniform best practice per technology area methodology and periodically revising the uniform best practice per technology area methodology based on a judicial action, a legislative action, a discontinuity and/or a regulatory action affecting the best practice methodology.

In addition, the employees of the foreign jurisdiction entity who display exceptional skill in performing the task portion of the patent legal services may be provided an incentive to become a patent professional in a primary jurisdiction through an educational opportunity reimbursement in the primary jurisdiction and/or a work status sponsorship in the primary jurisdiction. The patent attorney may be selected after an objective evaluation of a skill of the patent attorney in alignment with the uniform best practice per technology area methodology developed by the advisory board.

The method may yet include creating a linkage between the patent attorney and certain other patent attorneys in the network of patent attorneys through a common fraternal marker, such that the patent attorney and the other patent attorneys in the network of patent attorneys are recognizable as being preeminent practitioners of the patent law. The method may further include qualifying the foreign jurisdiction entity as a franchised entity of the network of patent attorneys based on a conformance with a particular portion of the uniform best practice per technology area methodology.

The method may include maintaining a governmental privilege (e.g., the governmental privilege may be an attorney client privilege and/or an attorney work product privilege) between the patent attorney and the client through the separate entity by performing the core portion of the patent legal service in the separate entity. The governmental privilege may be extended to employees of the foreign jurisdiction entity when performing the task portion under a supervision of the patent attorney.

In addition, confidentiality may be maintained by the network of patent attorneys to preserve client confidences through a set of purge and segmentation policies that ensure that confidential information does not escape a privileged workgroup formed between the patent attorneys and the foreign jurisdiction entity. The method may also include internally classifying the core portion and/or the task portion as being subject to an export control regulation and maintaining documentation of the core portion and/or the task portion in compliance with an automatic licensure procedure of the export control regulation prior to engaging the foreign jurisdiction entity with the task portion.

The method may yet include providing an engagement letter to the client to ensure that the client has previously exported any technology that is subjected to the export control regulation. The method may further include providing an assistant of the network of patent attorneys to the patent attorney to manage a workflow distribution, a finance function, an accounting function, an administrative function and/or a marketing function.

The method may also include generating an invoice of the separate entity using the finance function managed by the assistant of the network of patent attorneys, processing a payment of the client to the separate entity through the network of patent attorneys when the assistant performs the finance function and allocating a portion of the payment as a management consideration to the network of patent attorneys when the payment to the separate entity is processed.

The method may further include providing the separate entity of the patent attorney with the core portion of the patent legal service generated through a relationship directly between the network of patent attorneys and a different client, and compensating the patent attorney based on a satisfactory completion of the core portion of the patent legal service. In addition, the method may include balancing a service capacity in the network of patent attorneys by the patent attorney providing a referral to other patent attorneys of the network of patent attorneys when the patent attorney has an unavailable status, a conflict status, a vacation status, and/or an overloaded status.

The method may further include permitting the patent attorney to accept legal service engagements apart from the network of patent attorneys when the legal service engagements may not be in a patent related focus area of the network of patent attorneys. The method may also include managing a conflict of interest between the client and other clients of the patent attorney in the separate entity and/or creating an ethical separation (e.g., a physical separation, a patent support staff separation, a geographic separation, a task force separation, an electronic separation, a database separation, a communication separation, and/or a workflow separation) between tasks of the separate entity from other separate entities associated with the network of patent attorneys to address the conflict of interest.

The method may further include providing endemic services in the holistic patent services support solution including a patent paralegal support, an engineer allocation, a patent engineer allocation in a foreign jurisdiction, a patent agent allocation in the foreign jurisdiction, a search specialist allocation, a docketing clerk allocation in the foreign jurisdiction, and a patent illustrator allocation in the foreign jurisdiction.

The method may also include providing patent support services in the holistic patent services support solution including an organization formation service, a real estate service, an office management service, a training service, a marketing collaboration service, a recruiting service, a marketing cooperative service, an advertising cooperative service, a professional website creation service, a billing service, an accounting service, a matter management service, a consulting service, and/or a collections service.

In another aspect, a method of a professional service network includes providing a holistic professional support solution to a client-facing professional (e.g., may be recruited from an external network when the client-facing professional has an independent client base above a threshold value) forming a separate entity, permitting the separate entity to adopt a trade identity different than that of the professional service network, and performing a core portion of a professional service through the separate entity of the client-facing professional.

Further, the providing the holistic professional support solution may include segmenting a task portion of the professional service from the core portion of the professional service based on a skill level required to perform the task portion and the core portion, and improving a quality benchmark of the task portion of the professional service by performing the task portion in a foreign jurisdiction entity where a foreign labor rate permits the task portion to be dedicated additional time in a given budget.

The method may also include transferring a relationship between the client-facing professional and a client to the professional service network, marketing a corporate ownership interest of the professional service network to parties other than members of a trade organization to which the client-facing professional belongs without violating a regulation of the trade organization when the core portion is performed through the separate entity and a separate entity ownership interest may be owned entirely by the members of the trade organization.

In addition, the method may include providing the corporate ownership interest as stock options to the client-facing professional based on an origination revenue, an objective quality-benchmark of work product, tenure, and/or a client feedback rating of the client-facing professional. The method may further include selecting a foreign jurisdiction based on a writing skill profile, an education profile, an infrastructural profile, a judicial precedent profile, a political profile, a labor cost profile, a language proficiency profile, an economic profile, a cultural profile, and/or a special expertise profile.

The method may yet include training employees of the foreign jurisdiction entity through a uniform best practice per technology area methodology developed by an advisory board of industry recognized experts, providing an internal quality control team of the professional service network to monitor and/or manage adherence to the uniform best practice per technology area methodology, and periodically revising the uniform best practice per technology area methodology based on a judicial action, a legislative action, and/or a regulatory action affecting the best practice methodology.

Further, the employees of the foreign jurisdiction entity who display exceptional skill in performing the task portion of the professional service may be provided an incentive to become a client-facing professional in a primary jurisdiction through an educational opportunity reimbursement in the primary jurisdiction and/or a work status sponsorship in the primary jurisdiction. The client-facing professional may be selected after an objective evaluation of a skill of the client-facing professional in alignment with the uniform best practice per technology area methodology developed by the advisory board.

In addition, the method may include creating a linkage between the client-facing professional and other client-facing professionals in the professional service network through a common fraternal marker, such that the client-facing professional and the other client-facing professionals in the professional service network are recognizable as being preeminent practitioners in their professions. The method may also include qualifying the foreign jurisdiction entity as a franchised entity of the professional service network based on a conformance with a particular portion of the uniform best practice per technology area methodology.

The method may further include maintaining a governmental privilege between the client-facing professional and the client through the separate entity by performing the core portion of the professional service in the separate entity. The governmental privilege (e.g., an attorney client privilege and/or an attorney work product privilege) may be extended to the employees of the foreign jurisdiction entity when performing the task portion under a supervision of the client-facing professional. Confidentiality may be maintained by the professional service network to preserve client confidences through a set of purge and/or segmentation policies that ensure that a confidential information does not escape a privileged workgroup formed between the client-facing professional and the foreign jurisdiction entity.

The method may yet include internally classifying the core portion and/or the task portion as being subject to an export control regulation, and maintaining documentation of the core portion and/or the task portion may be maintained in compliance with an automatic licensure procedure of the export control regulation prior to engaging the foreign jurisdiction entity with the task portion.

The method may include providing an engagement letter to the client to ensure that the client has previously exported any technology that is subjected to the export control regulation. The method may include providing an assistant of the professional service network to the client-facing professional to manage a workflow distribution, a finance function, an accounting function, an administrative function, and/or a marketing function.

The method may also include generating an invoice of the separate entity using the finance function managed by the assistant of the professional service network, processing a payment of the client to the separate entity through the professional service network when the assistant performs the finance function, and allocating a portion of the payment as a management consideration to the professional service network when the payment to the separate entity is processed.

The method may further include providing the separate entity of the client-facing professional with the core portion of the professional service generated through a relationship directly between the professional service network and a different client, and compensating the client-facing professional based on a satisfactory completion of the core portion of the professional service. The method may also include balancing a service capacity in the professional service network by the client-facing professional providing a referral to other client-facing professionals of the professional service network when the client-facing professional has an unavailable status, a vacation status, and/or an overloaded status.

In addition, the method may include permitting the client-facing professional to accept professional service engagements apart from the professional service network when the professional service engagements are not in a category focus area of the professional service network. The method may further include managing a conflict of interest between the client and other clients of the client-facing professional in the separate entity, and creating an ethical separation (e.g., physical separation, support staff separation, geographic separation, task force separation, electronic separation, database separation, communication separation, and/or workflow separation) between tasks of the separate entity from other separate entities associated with the professional service network to address the conflict of interest.

The method may further include providing endemic services in the holistic professional support solution including a paralegal support, an apprentice allocation in a foreign jurisdiction, an illustrator allocation in the foreign jurisdiction, and/or an engineer allocation in the foreign jurisdiction.

The method may also include providing support services in the holistic professional support solution including an organization formation service, a real estate service, an office management service, a training service, a marketing collaboration service, a recruiting service, a marketing cooperative service, an advertising cooperative service, a professional website creation service, a billing service, an accounting service, a matter management service, a consulting service, and/or a collections service.

In yet another aspect, a method of a separate entity includes performing a task portion of a professional service through a foreign jurisdiction entity where a foreign labor rate permits the task portion to be dedicated additional time in a given budget, and preserving a client confidence through a set of policies that ensure that a confidential information does not escape a privileged workgroup formed between a client-facing professional of the separate entity and a partitioned team of the foreign jurisdiction entity. The method may further include providing a management fee to the foreign jurisdiction entity when a payment of the professional service may be collected by the foreign jurisdiction entity on behalf of the separate entity.

In addition, the method may include accepting a corporate ownership interest incentive in the foreign jurisdiction entity and/or an enabling entity of the foreign jurisdiction entity based on an origination revenue, an objective quality-benchmark of work product, a tenure, and/or a client feedback rating of the client-facing professional of the separate entity. The method may also include internally classifying a core portion and/or the task portion as being subject to an export control regulation, and maintaining documentation of the core portion and/or the task portion in compliance with an automatic licensure procedure of the export control regulation prior to engaging the foreign jurisdiction entity with the task portion.

The method may further include screening in the separate entity a conflict of interest risk between clients of the separate entity and creating a physical and/or electronic barrier of work product accessibility of the separate entity by other separate entities and support teams of the foreign jurisdiction entity. In addition, the separate entity, the other separate entities, and/or the foreign jurisdiction entity may be members of a globalized professional service network which provides best practices training of the professional service to its members, which may provide a comprehensive practice startup and/or support solution to the separate entity and/or the other separate entities through the foreign jurisdiction entity, and in which members of the professional service network provide referrals to other members of the professional service network.

In a further aspect, a system includes a network of separate entities formed and managed by an enabling organization, a central organization of the enabling organization to provide support services to the network of separate entities, and a group of clients having a portion of a service performed using the central organization through an oversight by some experienced professionals of the separate entities. The central organization may be located in a jurisdiction selected based on a writing skill profile, an education profile, an infrastructural profile, a judicial precedent profile, a political profile, a labor cost profile, a language proficiency profile, an economic profile, a cultural profile, and/or a special expertise profile of the jurisdiction.

The enabling organization may perform a set of services for each separate entity of the network of separate entities including an organization formation service, a real estate service, an office management service, a training service, a marketing collaboration service, a recruiting service, a marketing cooperative service, an advertising cooperative service, a professional website creation service, a billing service, an accounting service, a matter management service, a consulting service, a billing service, and/or a collections service. In addition, the central organization and the enabling organization may be a single corporate entity owned partly by the network of separate entities.

The methods, systems, and apparatuses disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

Example embodiments are illustrated by way of example and not limitation in the figures of the accompanying drawings, in which like references indicate similar elements and in which:

FIG. 1 is a system view of an enabled network of independent professional entities, according to one embodiment.

FIG. 2 is an exploded view of the enabling module of FIG. 1, according to one embodiment.

FIG. 3 is an exploded view of the central module of FIG. 1, according to one embodiment.

FIG. 4 is a global system view of the enabled network of independent professional entities of FIG. 1, according to one embodiment.

FIG. 5 is a table view of data referenced by the account database of FIG. 2, according to one embodiment.

FIG. 6 is a user interface view of a marketing module of FIG. 2, according to one embodiment.

FIG. 7 is a chart view of a revenue distribution comparison between an independent entity and an external entity, according to one embodiment.

FIG. 8 is a market growth rate chart of a work product relevant to an independent entity, according to one embodiment.

FIG. 9 is a diagrammatic system view of a data processing system in which any of the embodiments disclosed herein may be performed, according to one embodiment.

FIG. 10A is a process flow of providing patent legal services to a patent attorney forming a separate entity, according to one embodiment.

FIG. 10B is a continuation of the process flow of FIG. 10A, illustrating additional processes, according to one embodiment.

FIG. 10C is a continuation of the process flow of FIG. 10B, illustrating additional processes, according to one embodiment.

FIG. 10D is a continuation of the process flow of FIG. 10C, illustrating additional processes, according to one embodiment.

FIG. 11A is a process flow of providing professional services to a client-facing professional forming a separate entity, according to one embodiment.

FIG. 11B is a continuation of the process flow of FIG. 11A, illustrating additional processes, according to one embodiment.

FIG. 11C is a continuation of the process flow of FIG. 11B, illustrating additional processes, according to one embodiment.

FIG. 11D is a continuation of the process flow of FIG. 11C, illustrating additional processes, according to one embodiment.

FIG. 12 is a process flow of performing a task portion of a professional service through a foreign jurisdiction entity and preserving a client confidence through a set of policies, according to one embodiment.

FIG. 13 is a process flow chart to determine a compliance of an item with an export control regulation, according to one embodiment.

FIG. 14 is a system view of network of client-facing professionals, according to one embodiment.

FIG. 15 is a system view of a quality control process of an organization, according to one embodiment.

FIG. 16 is a user interface view of an online marketplace of intellectual property, according to one embodiment.

FIG. 17 is a process flow view of various steps of patent application drafting, according to one embodiment.

Other features of the present embodiments will be apparent from the accompanying drawings and from the detailed description that follows.

### DETAILED DESCRIPTION

A method, apparatus and system of segmented services having a global structure of networked independent entities are disclosed. In the following description, for the purposes of explanation, numerous specific details are set forth in order to provide a thorough understanding of the various embodiments. It will be evident, however to one skilled in the art that the various embodiments may be practiced without these specific details.

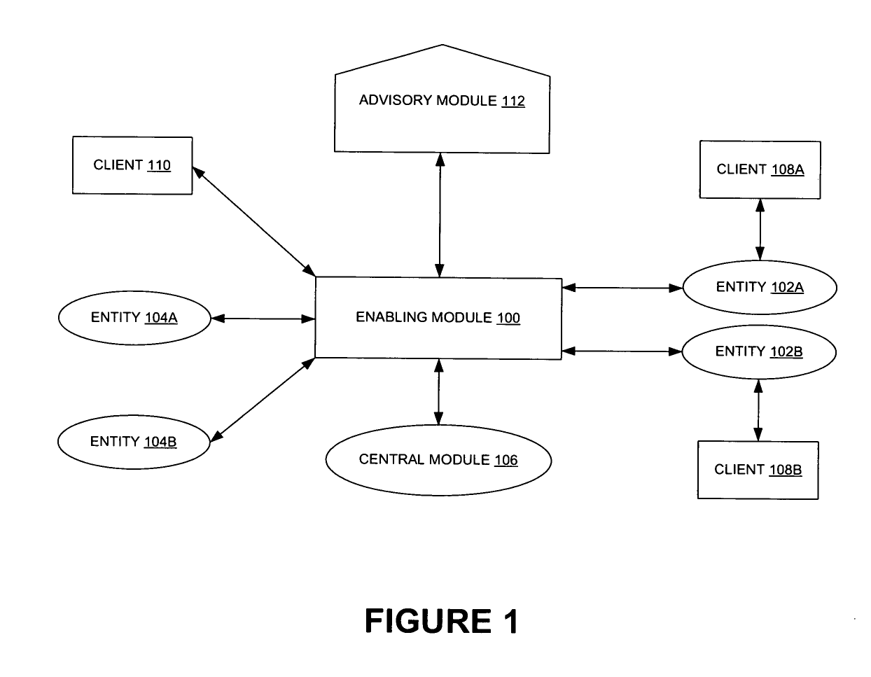

In one embodiment, a method of a network of patent attorneys includes providing a holistic patent services support solution to a patent attorney forming a separate entity (e.g., the entities 102A-B of FIG. 1), permitting the separate entity 102 to adopt a trade identity different than that of the network of patent attorneys, and performing a core portion of a patent legal service through the separate entity 102 of the patent attorney.

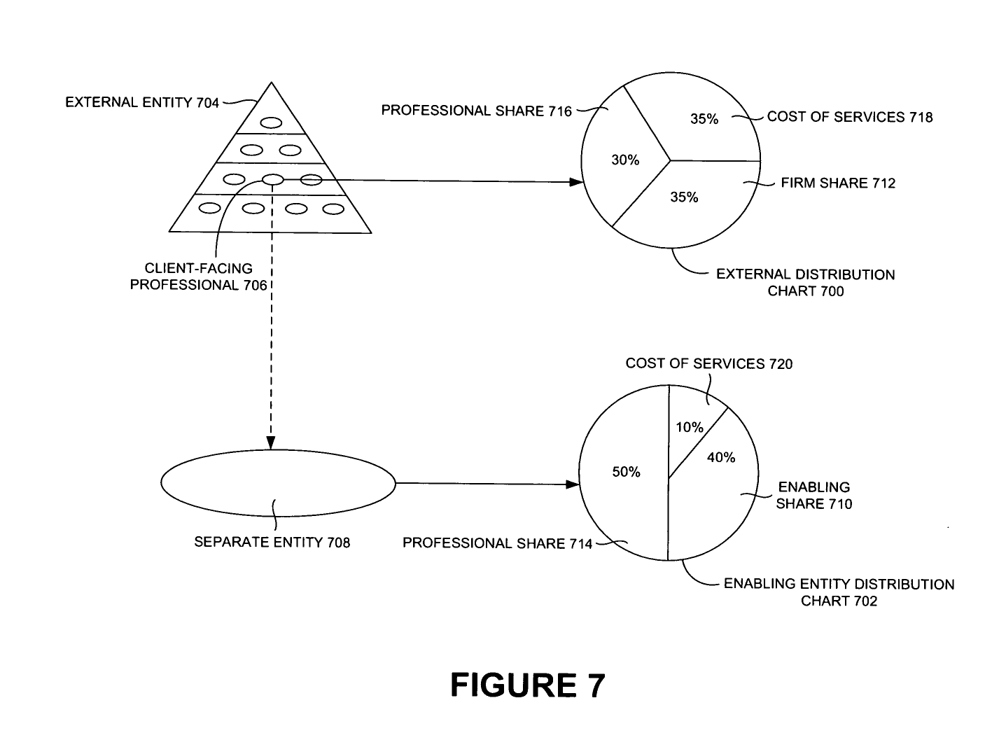

In another embodiment, a method of a professional service network includes providing a holistic support solution (e.g., support services endemic and/or auxiliary to a focus area) to a client-facing professional (e.g., an attorney, a medical practitioner, a consultant, an accountant, and/or an architect, etc.) forming a separate entity (e.g., the separate entity 104 of FIG. 1), permitting the separate entity 104 to adopt a trade identity different than that of the professional service network, and performing a core portion of the professional service through the separate entity 104 of the client-facing professional (e.g., the client-facing professional 706 of FIG. 7).

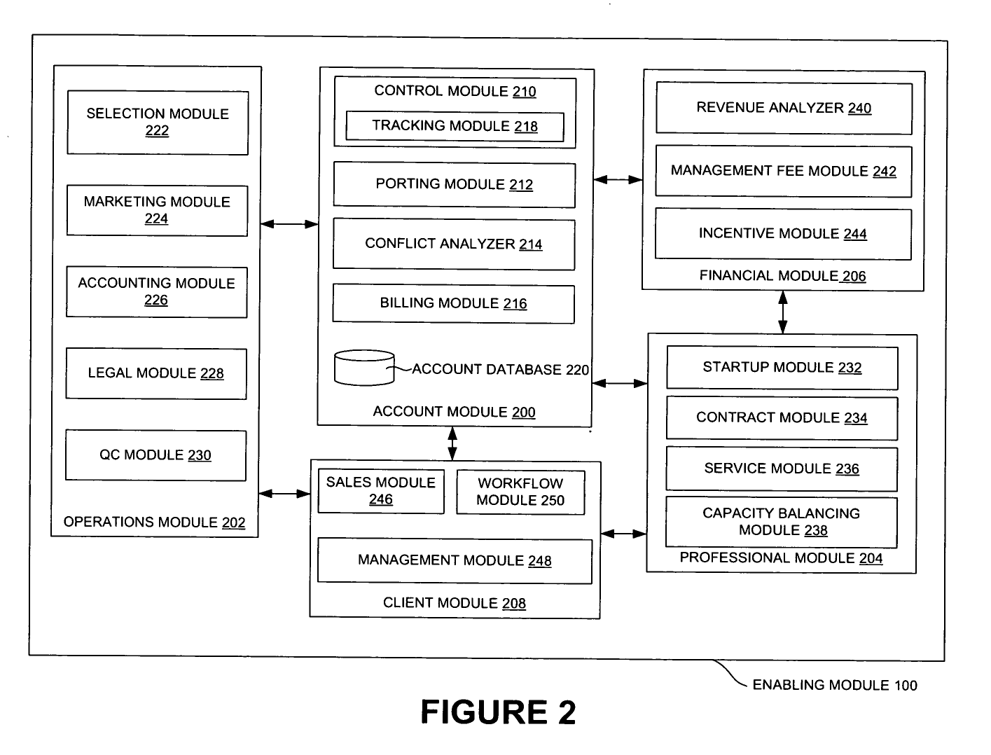

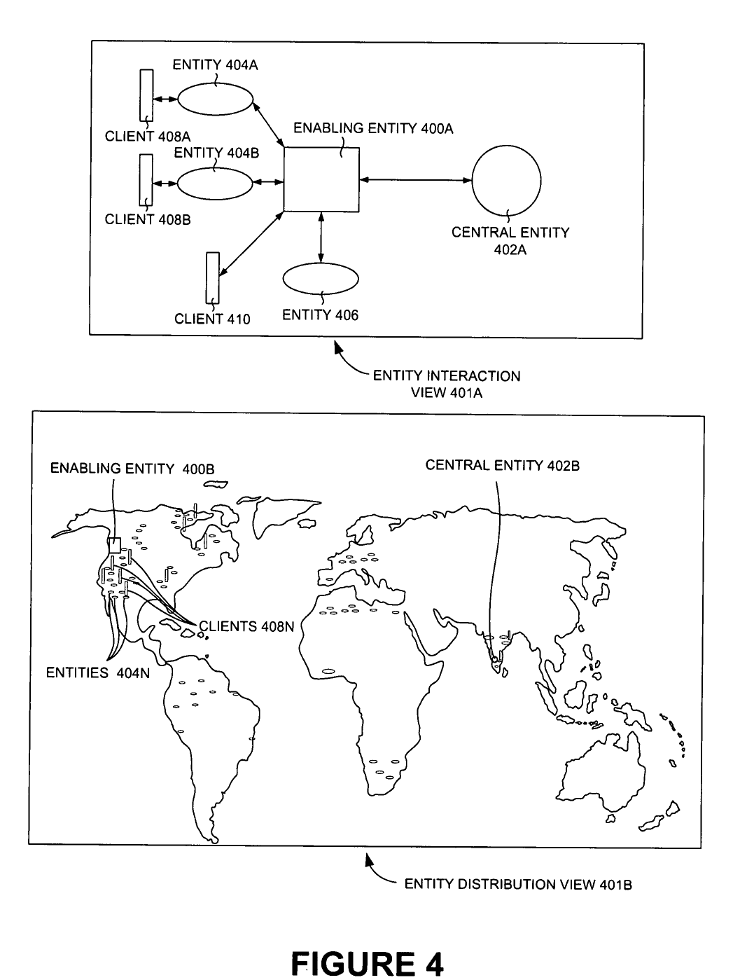

In yet another embodiment, a method of a separate entity (e.g., the separate entity 708 of FIG. 7) includes performing a task portion of a professional service (e.g., based on a segmentation of the task portion and a core portion of the professional service based on a skill level required to perform a service) through a foreign jurisdiction entity (e.g., the central entity 402 of FIG. 4) where a foreign labor rate permits the task portion to be dedicated additional time in a given budget, and preserving a client confidence (e.g., using a control module 210 of FIG. 2) through a set of policies that ensure that a confidential information does not escape a privileged workgroup (e.g., formed between a client-facing professional 706 of the separate entity 708 and a partitioned team of the foreign jurisdiction entity 402).

In a further embodiment, a network of separate entities 708 formed and/or managed by an enabling organization (e.g., the enabling entity 400 of FIG. 4) may include a central organization (e.g., the central entity 402 of FIG. 4) of the enabling organization 400 to provide support services (e.g., task portions of professional services) to the network of separate entities 102A-B and/or separate entities 104 A-B, and a group of clients (e.g., the clients 108 and/or the clients 110 of FIG. 1) having a portion of a service performed using the central organization 402 through an oversight by experienced professionals of the separate entities 708 (e.g., using the QC module 230 of FIG. 2).

FIG. 1 is a system view of an enabled network of independent professional entities, according to one embodiment. Particularly, FIG. 1 illustrates an enabling module 100, entities 102A-B, entities 104A-B, a central module 106, clients 108A-B, a client 110 and an advisory board 112, according to one embodiment.

The enabling module 100 may be a corporate entity (e.g., a company, an organization, a firm, an alliance, an association, and/or a venture, etc.) that may provide a holistic support solution, an assistance, a best practice, a patronage, training, and/or a benefaction to patent attorneys forming separate entities 102 A-B and/or to a professional service network of client-facing professionals 706 in a foreign jurisdiction to manage a finance function, an accounting function, an administrative function, a marketing function, an operational function, and/or a workflow distribution, etc. The entities 102 A-B and 104 A-B may be client-facing professionals 706 (e.g., attorneys, engineers, accountants, consultants, and/or specialists, etc.) associated with the network of separate entities 708 (e.g., having distinct trade identities) who may have left external networks to begin their own practices (e.g., a law firm, accounting practices, consulting practices, and/or engineering practices, etc.).

The central module 106 may be a corporate entity, a franchised entity, a professional service entity located in the foreign jurisdiction where a foreign labor rate permits a task portion to be dedicated additional time in a given budget (e.g., may allow additional hours to be allocated to the task portion of a professional service within a budget constraint based on a cost associated with a time spent in performing the task portion). The central module 106 may provide (e.g., through the enabling module 100 of FIG. 1) a holistic support solution (e.g., comprehensive support services, supplementary services, and/or endemic services, etc.) to the patent attorneys and/or the client-facing professionals 706 of the professional service network located in the foreign jurisdiction.

The clients 108A-B and the client 110 may be a firm, an inventor, an investor, a patron, an organization, a creator, an author, a research fellow, etc. associated with anyone of the entities 102A-B, the entities 104A-B and the enabling module 100 where the entities 104 A-B may not have formed their own client relationship in a particular state prior to joining the professional service network. The advisory module 112 may be associated with a group of experts (e.g., specialists, professionals, trainers, researchers, examiners, and/or counselors, etc.) developing and/or revising a uniform best practice per technology area methodology (e.g., a set of practices associated with technology areas) based on judicial action, legislative action, and/or regulatory action affecting a best practice methodology for training employees of the foreign jurisdiction entity 402. The advisory module 112 may perform an objective evaluation of skills of the client-facing professionals 706 in alignment with the uniform best practice per technology area methodology.

In the example embodiment illustrated in FIG. 1, the enabling module 100 communicates with the entities 102A-B, the entities 104A-B, the central module 106, the client 110 and the advisory module 112. The entities 102A-B as illustrated in FIG. 1, communicates with the clients 108A-B.

In one embodiment, a holistic patent services support solution may be provided to a patent attorney forming a separate entity (e.g., the separate entity 708 of FIG. 7). The separate entity 708 may be permitted to adopt a trade identity different than that of a network of patent attorneys. A core portion of a patent legal service may be performed through the separate entity 708 of the patent attorney.

A relationship between the patent attorney and the client 110 may be transferred to the network of the patent attorneys (e.g., associated with the central module 106 of FIG. 1). A corporate ownership interest of the network of patent attorneys may be marketed to parties other than members of a State Bar Association to which the patent attorney belongs without violating a regulation of the State Bar Association when the core portion is performed through the separate entity (e.g., the entities 102A-B and the entities 104A-B of FIG. 1). A separate entity ownership interest may be owned entirely by the members of the State Bar Association.

Further, employees of the foreign jurisdiction entity 402 may be trained through a uniform best practice per technology area methodology developed by the advisory board 112 of recognized experts in a field of patent law (e.g., may include attorneys, agents, patent examiners, etc.). An internal quality control team of the network of patent attorneys may be provided to monitor and/or manage adherence to the uniform best practice per technology area methodology. In addition, the uniform best practice per technology area methodology may be periodically revised based on judicial action, legislative action, discontinuity and/or regulatory action affecting the best practice methodology. The separate entity 708 of the patent attorney may be provided with the core portion of the patent legal service generated through a relationship directly between the network of patent attorneys and a different client 110. The patent attorney may compensated based on a satisfactory completion of the core portion of the patent legal service.

In another embodiment, a holistic professional support solution may be provided to a client-facing professional 706 forming a separate entity 708. The separate entity 708 may be permitted to adopt a trade identity different than that of a professional service network. The core portion of the professional service may be performed through the separate entity 708 of the client-facing professional 706.

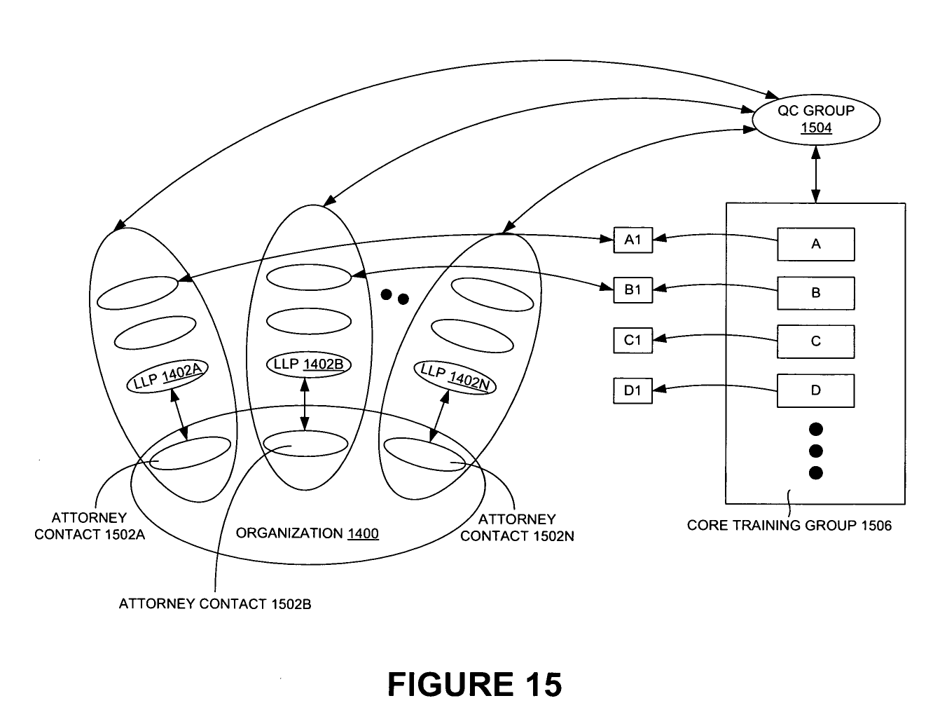

Further, employees of the foreign jurisdiction entity 402 may be trained through the uniform best practice per technology area methodology developed by the advisory board 112 of industry recognized experts. The internal quality control team (e.g., the QC group 1504 of FIG. 15) of the professional service network may be provided to monitor and/or manage adherence to the uniform best practice per technology area methodology. The uniform best practice per technology area methodology may be periodically revised based on judicial action, legislative action, discontinuity and/or regulatory action affecting the best practice methodology.

The separate entity 708 of the client-facing professional 706 may be provided with the core portion of a professional service generated through a relationship directly between the professional service network (e.g., the network associated with the enabling module 100 and central module 106 of FIG. 1) and a different client 110. The client-facing professional 706 may be compensated based on a satisfactory completion of the core portion of the professional service.

A conflict of interest risk between clients 108A-B of the separate entity 102 may be screened in the separate entity 102. A physical and/or electronic barrier of work product accessibility of the separate entity 102 may be created by other separate entities 708 and/or support teams of the foreign jurisdiction entity 402.

In accordance with one or more embodiments, a network of separate entities 102A-B and 104A-B may be formed and/or managed by an enabling organization (e.g., the enabling entity 400 of FIG. 4). A central organization (e.g., the central module 106 of FIG. 1) of the enabling organization 400 may provide support services to the network of separate entities 102A-B and 104A-B and/or a group of clients 110 A-B having a service performed using the central organization 402 through an oversight by experienced professionals of the separate entities 102A-B and 104A-B. For example, the central organization 402 and/or the enabling organization 400 may be a single corporate entity owned partly by the network of separate entities 102A-B and 104A-B.

FIG. 2 is an exploded view of the enabling module 100 of FIG. 1, according to one embodiment. Particularly, FIG. 2 illustrates an account module 200, an operations module 202, a professional module 204, a financial module 206, a client module 208, a control module 210, a porting module 212, a conflict analyzer 214, a billing module 216, a tracking module 218, a selection module 222, a marketing module 224, an accounting module 226, a legal module 228, a QC module 230, a startup module 232, a contract module 234, a service module 236, a capacity balancing module 238, a revenue analyzer 240, a management fee module 242, an incentive module 244, a sales module 246 and a management module 248, according to one embodiment.

The account module 200 may include a control module 210 (e.g., illustrated as having the tracking module 218), the porting module 212, the conflict analyzer 214, the billing module 216, and/or the account database 220. The account module 200 may process (e.g., capture, store, track, generate, record, monitor, access, and/or communicate, etc.) accounts (e.g., dockets, billing records, cases, files, matters, correspondences, etc.) associated with a set of client books (e.g., client accounts associated with clients 108 A-B of the entities 102A-B and/or the entities 104A-B of FIG. 1).

The control module 210 may ensure that client confidences may be preserved through a set of policies such that confidential information does not escape a privileged workgroup formed between the client-facing professional 706 of the separate entity 708 and a partitioned team of the foreign jurisdiction entity 402. The tracking module 218 may internally classify a core portion and a task portion as being subject to an export control regulation (e.g., and/or may maintain documentation of the core portion and/or the task portion in compliance with an automatic licensure procedure of the export control regulation) prior to engaging the foreign jurisdiction entity 402 through the central module 106 with the task portion of the professional service.

The porting module 212 may process (e.g., control, monitor, track, transfer analyze, preserve, etc.) a transfer of a client relationship (e.g., between a client 108 or a client 110 and a client-facing professional 706 joining and/or being recruited into the professional service network), a book of business, a client accounts, etc. to the professional service network through the enabling module 100. The conflict analyzer 214 may process (e.g., analyze, assess, compare, track, and/or monitor, etc.) a screening of a conflict of interest risk between potential clients 110 and/or current clients 108 A-B of an external entity 704 of the professional service network and other entities 102 A-B and/or entities 104 A-B of the professional service network.

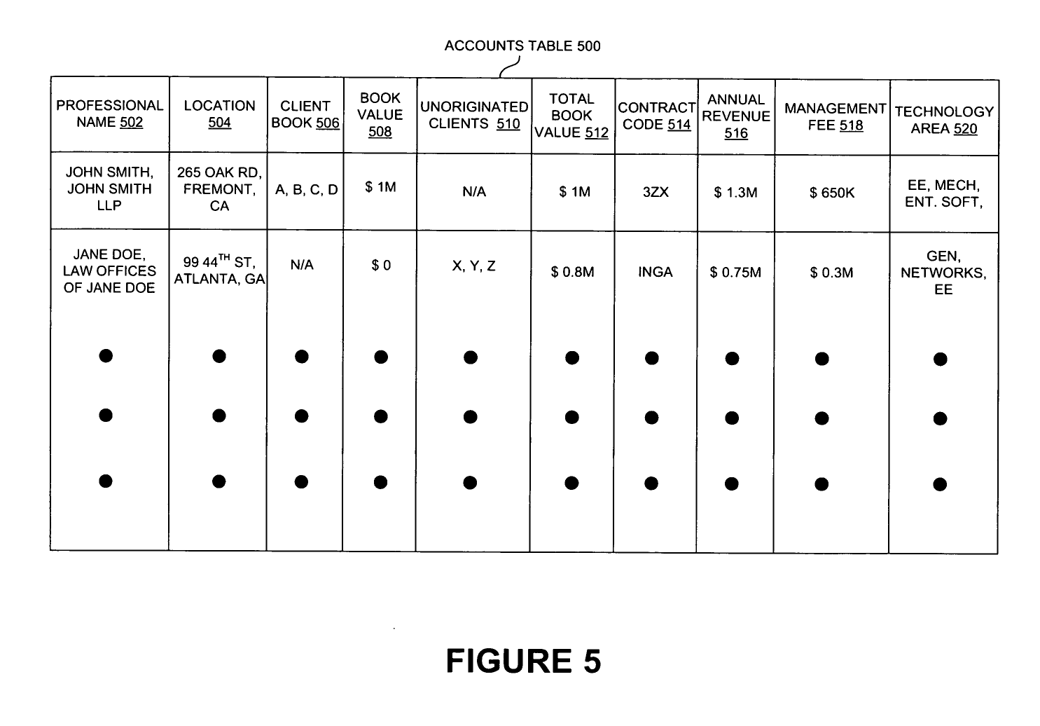

The billing module 216 may process an allocation of resources associated with the core portion of the professional service performed by the client-facing professional 706 and/or the task portion of the professional service facilitated by the central module 106 through a support team of the foreign jurisdiction entity 402 associated with the client-facing professional 706. The account database 220 may store data and/or meta-data associated with information processed by the account module 200, and is best understood with reference to FIG. 5.

The operations module 202 may include the selection module 222, the marketing module 224, the accounting module 226, the legal module 228, and the QC module 230. The selection module 222 may process a selection (e.g., recruitment) of client-facing professionals 706 into the professional service network based on an objective evaluation of a skill of the client-facing professional 706 in alignment with the uniform best practice per technology area methodology developed by a advisory board (e.g., using the advisory module 112 of FIG. 1). The marketing module 224 may process marketing (e.g., multi-level marketing) tasks (e.g., public relations campaigns, positioning strategies, branding strategies, advertising campaigns, etc.) targeted to specific audiences including clients 108 A-B and/or clients 110, and/or client-facing professionals 706 in external networks.

The accounting module 226 may process various accounting and/or bookkeeping functions associated with operations of the enabling module 100 (e.g., tax reporting, financial records, internal audits, etc.). The legal module 228 may process various legal functions associated with the operations of the enabling module 100 (e.g., entity formation, corporate legal requirements, interactions with external entities and/or networks, etc.). The legal module 228 may provide patent legal services to patent attorneys forming separate entities 708. The QC (e.g., quality control) module 230 may process (e.g., monitor, track, oversee, direct, correct, complete, manage, analyze, etc.) a quality benchmark associated with work products of the client-facing professionals 706 in various technology areas (e.g., based on a communication with the advisory module 112).

The professional module 204 may include the startup module 232, the contract module 234, the service module 236, and the capacity balancing module 238. The startup module 232 may process and/or provide a holistic support solution to the client-facing professional 706 and/or patent attorneys recruited into the professional service network and/or the network of patent attorneys. The contract module 234 may process (e.g., formalize, define, record, establish, etc.) a relationship among the client-facing professional 706, the separate entity 102, the separate entity 104 associated with the client-facing professional 706, the enabling module 100 and the central module 106.

The capacity balancing module 238 may balance a service capacity in a network (e.g., a professional service network, a network of patent attorneys) by the client-facing professionals 706 providing referrals to other client-facing professionals 706 of the professional service network associated with the enabling module 100 (e.g., based on unavailable status, conflict status, technology area, vacation status, and/or overloaded status etc.). The service module 236 may interact with the central module 106 to process a holistic support solution (e.g., having endemic and/or auxiliary services) provided to the client-facing professionals 706 and/or the patent attorneys.

The financial module 206 may include the revenue analyzer 240, the management fee module 242, and the incentive module 244. The financial module 206 may generate an invoice of the separate entity 102 A-B associated with clients 108A-B and/or the separate entity 104 associated with an enabling entity 400, and/or may process a payment by the clients 108A-B and/or the client 110 to the separate entity 104 and the separate entity 102 associated with the clients 108A-B. The revenue analyzer 240 may process (e.g., analyze) a revenue generated by the clients 108 A-B and/or the client 110 based on billings generated through the core portion of the professional service performed for the clients 108 A-B and/or the client 110 by the client-facing professional 706.

The management fee module 242 may process a portion of the payment by the clients 108 A-B and 110 as a management consideration to the professional service network. The incentive module 244 may permit the client-facing professional 706 to accept a corporate ownership interest incentive in the foreign jurisdiction entity 402 associated with the central module 106 based on origination revenue, objective quality-benchmark of work product, tenure, and client feedback rating of the client-facing professional 706 of the separate entity 708.

The client module 208 may include the sales module 246, the management module 248, and the workflow module 250. The sales module 246 may communicate (e.g., directly and/or indirectly) with potential clients 108A-B and 110 to generate a workflow (e.g., of the professional service work). The sales module 246 may deploy specialized representatives, certain client-facing professionals 706, and/or parties associated with the advisory module 112 in a communication with the potential clients.

The management module 248 may process (e.g., monitor, enhance, and/or improve, etc.) client relationships between the client-facing professionals 706 and the clients 108 A-B and 110 sourced directly through the sales module 246, and/or communicate with the advisory module 112 and the operations module 202 to optimize certain aspects of the client relationships based on an assessment of the client relationship. The workflow module 250 may process (e.g., analyze) the workflow generated and/or transfer (e.g., substitute, backfill, etc.) the workflow to various client-facing professionals 706 in the professional service network (e.g., based on availability status, technology area status, conflict status, and/or capacity status, etc.).

In the example embodiment illustrated in FIG. 2, the account module 200 communicates with the operations module 202, the professional module 204, the financial module 206 and the client module 208. The operations module 202 communicates with the account module 200 and the client module 208. The professional module 204 interacts with the account module 200, the financial module 206, and the client module 208. The financial module 206 also communicates with the account module 200 and the professional module 204.

In one embodiment, employees of the foreign jurisdiction entity 402 who display exceptional skill in performing a task portion of patent legal services may be provided an incentive (e.g., through the incentive module 244 of FIG. 2) to become a patent professional (e.g., a patent attorney, a patent agent, etc.) in a primary jurisdiction through an educational opportunity reimbursement in the primary jurisdiction and a work status sponsorship in the primary jurisdiction. The patent attorney may be selected after an objective evaluation of a skill of the patent attorney in alignment with the uniform best practice per technology area methodology developed (e.g., using the advisory module 112 of FIG. 1) by the advisory board.

A linkage may be created between the patent attorney and certain other patent attorneys in the network of patent attorneys through a common fraternal marker, such that the patent attorney and/or the other patent attorneys in the network of patent attorneys are recognizable as being preeminent practitioners of patent law. A core portion and a task portion as being subject to an export control regulation may be internally classified. Documentation of the core portion and/or the task portion may be maintained in compliance with an automatic licensure procedure of the export control regulation prior to engaging the foreign jurisdiction entity 402 with the task portion.

An engagement letter may be provided to the client 110 to ensure that the client 110 has previously exported any technology that may subject to the export control regulation. An assistant of the network of patent attorneys may be provided to the patent attorney to manage a workflow distribution (e.g., using the workflow module 250 associated with the client module 208 of FIG. 2), a finance function (e.g., using the financial module 206 of FIG. 2), an accounting function (e.g., using the account module 200 of FIG. 2), an administrative function (e.g., the professional module 204 of FIG. 2), and a marketing function (e.g., using the operations module 202 of FIG. 2). An invoice of the separate entity 102 may be generated using the finance function managed by the assistant of the network of patent attorneys. The payment of the client 108 to the separate entity 102 may be processed through the network of patent attorneys when the assistant performs the finance function. A portion of the payment may be allocated as a management consideration to the network of patent attorneys when the payment to the separate entity 102 is processed.

A service capacity may be balanced in the network of patent attorneys (e.g., using the capacity balancing module 238 associated with the professional module 204 of FIG. 2) by a patent attorney providing a referral to other patent attorneys of the network of patent attorneys when the patent attorney has unavailable status, conflict status, vacation status, and/or overloaded status. The patent attorney may be permitted to accept legal service engagements apart from the network of patent attorneys when the legal service engagements are not in a patent related focus area of the network of patent attorneys. The conflict of interest between a client 110 and other clients 108A-B of the patent attorney may be managed in the separate entity 102. An ethical separation between tasks of the separate entity 102 from other separate entities 104 A-B associated with the network of patent attorneys may be created to address the conflict of interest. For example, the ethical separation may include physical separation, patent support staff separation, geographic separation, task force separation, electronic separation, database separation, communication separation, and/or workflow separation, etc.

In another embodiment, a client-facing professional 706 may be selected after an objective evaluation of a skill of the client-facing professional 706 in alignment with the uniform best practice per technology area methodology developed by the advisory board 112. A linkage may be created between the client-facing professional 706 and certain other client-facing professionals 706 in a professional service network through a common fraternal marker, such that the client-facing professional 706 and the other client-facing professionals 706 in the professional service network are recognizable as being preeminent practitioners in their professions.

Further, a core portion and a task portion may be classified internally as being subject to an export control regulation. Documentation of the core portion and the task portion may be maintained in compliance with an automatic licensure procedure of the export control regulation prior to engaging the foreign jurisdiction entity 402 with the task portion. An engagement letter may be provided to a client 110 to ensure that the client 110 has previously exported any technology that is subject to the export control regulation. An assistant of the professional service network may be provided to the client-facing professional 706 to manage a workflow distribution (e.g., using the workflow module 250 associated with the client module 208 of FIG. 2), a finance function, (e.g., using the financial module 206 of FIG. 2), an accounting function (e.g., using the account module 200 FIG. 2), an administrative function (e.g., the professional module 204 of FIG. 2), and/or a marketing function (e.g., using the operations module 202 of FIG. 2).

An invoice of a separate entity 104 may be generated using the finance function managed by the assistant of the professional service network. A payment of the client 108 to the separate entity 102 may be processed through the professional service network when the assistant performs the finance function and a portion of the payment may be allocated as a management consideration to the professional service network when the payment to the separate entity 102 is processed.

A service capacity may be balanced in the professional service network (e.g., using the capacity balancing module 238 associated with the professional module 204) by the client-facing professional 706 providing referral to other client-facing professionals 706 of the professional service network when the client-facing professional 706 has unavailable status, conflict status, vacation status, and/or overloaded status, etc. The client-facing professional 706 may be permitted to accept professional service engagements apart from the professional service network when the professional service engagements are not in a category focus area of the professional service network.

The conflict of interest between the client 110 and other clients' 108A-B of the client-facing professional 706 may be engaged in the separate entity 102. An ethical separation may be created between tasks of the separate entity 102 from other separate entities 104 A-B associated with the professional service network to address the conflict of interest. A management fee may be provided (e.g., using the management fee module 242 associated with the financial module 206 of FIG. 2) to the foreign jurisdiction entity 402 when a payment of the professional service is collected by the foreign jurisdiction entity 402 on behalf of the separate entity 102.

The corporate ownership interest incentive in the foreign jurisdiction entity 402 and an enabling entity 400 of the foreign jurisdiction entity 402 may be accepted based on origination revenue, objective quality-benchmark of work product, tenure, and/or client feedback rating of the client-facing professional 706 of the separate entity 708.

For example, the enabling organization (e.g., the enabling entity 400 of FIG. 4) may perform a set of services for each separate entity 104 including organization formation service, real estate service, office management service, training service, marketing collaboration service, a recruiting service, marketing cooperative service, advertising cooperative service, professional website creation service, billing service, accounting service, matter management service, consulting service, and/or collections service, etc.

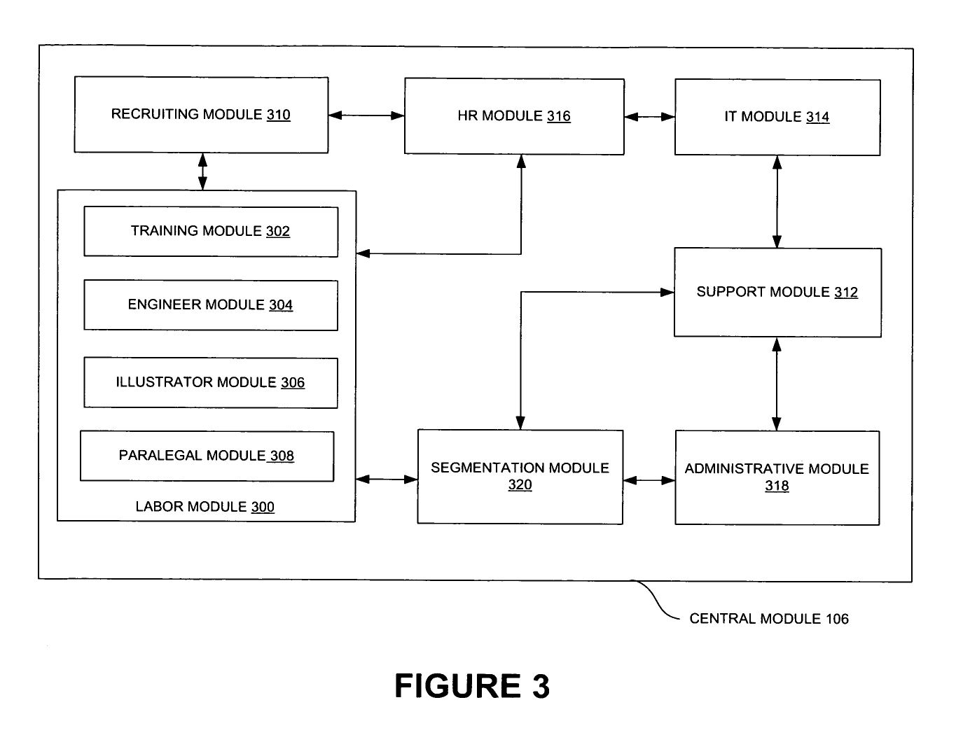

FIG. 3 is an exploded view of the central module 106 of FIG. 1, according to one embodiment. Particularly, FIG. 3 illustrates a labor module 300, a training module 302, an engineer module 304, an illustrator module 306, a paralegal module 308, a recruiting module 310, a support module 312, an IT (e.g., information technology) module 314, a HR (e.g., human resources) module 316, an administrative module 318 and a segmentation module 320, according to one embodiment.

The labor module 300 may include the training module 302, the engineer module 304, the illustrator module 306, and the paralegal module 308. The training module 302 may process a training (e.g., through an interaction with the enabling module 100 and/or the advisory module 112 of FIG. 1) of a support team associated with a task portion of services performed for the client-facing professionals 706. The engineer module 304 may manage (e.g., co-ordinate, monitor, analyze, etc.) engineer members of the support team associated with the task portion performed for the client-facing professional 706 of the entity 102 and/or the entity 104 of the professional service network.

The illustrator module 306 may manage (e.g., coordinate, monitor, and/or direct, etc.) illustrator members of the support team associated with the task portion performed for the client-facing professional 706 of the separate entity 102 and/or the separate entity 104 of the professional service network. The paralegal module 308 may manage paralegal members of the support team associated for the task portion performed for the client-facing professional 706 of the entity 102 and/or the entity 104 of the professional service network. The recruiting module 310 may develop a process to recruit (e.g., hire, contract, etc.) talented, suitable and qualified professionals (e.g., engineers, journalist, attorneys, medical practitioners, etc.).

In one embodiment, the support module 312 may provide a holistic patent service support solution to patent attorneys forming separate entities 708. In another embodiment, the support module 312 may provide a holistic professional support solution to client-facing professionals 706 of a professional service network. For example, a support service may include organization formation service, real estate service, office management service, training service, marketing collaboration service, recruiting service, advertising cooperative service, professional website creation service, billing service, accounting service, matter management service, consulting service, and/or, collections service, etc. The IT module 314 may process auxiliary technology and/or technical services associated with operations of the central module 106. The HR module 316 may monitor (e.g., manage, direct, analyze, and/or coordinate, etc.) data associated with the support team of a foreign jurisdiction entity 402 associated with the enabling module 100.

The administrative module 318 may process various functions associated with operations of central module 106. The segmentation module 320 may preserve client confidences between client-facing professionals 706 by implementing and/or monitoring a set of segmentation and purge policies so that confidential information does escape from a privileged workgroup.

In the example embodiment illustrated in FIG. 3, the labor module 300 includes the training module 302, the engineer module 304, the illustrator module 306 and the paralegal module 308, communicating with the recruiting module 310, the HR module 316 and the segmentation module 320. The support module 312 communicates with the IT module 314, the administrative module 318 and the segmentation module 320.

The IT module 316 interacts with the support module 312 and the HR module 316. The administrative module 318 communicates with the support module 312 and segmentation module 320. In one embodiment, a holistic patent services support solution includes segmenting (e.g., using the segmentation module 320 of FIG. 3) a task portion of a professional service from a core portion of a patent legal service based on a skill level required to perform the task portion and the core portion. A quality benchmark of the task portion of the patent legal service may be improved by performing the task portion in a foreign jurisdiction entity 402 where a foreign labor rate permits the task portion to be dedicated additional time in a given budget. A corporate ownership interest may be provided as stock options to a patent attorney based on origination revenue, objective quality-benchmark of work product, tenure, and/or client feedback rating of the patent attorney.

For example, a foreign jurisdiction may be selected based on writing skill profile, an education profile, an infrastructural profile, a judicial precedent profile, a political profile, a labor cost profile, a language proficiency profile, an economic profile, a cultural profile, and/or a special expertise profile, etc. Employees of the foreign jurisdiction entity 402 may be balanced (e.g., using the capacity balancing module 238 associated with the professional module 204 of FIG. 2) through a uniform best practice per technology area methodology developed by the advisory board 112 of recognized experts in a field of patent law (e.g., may include patent examiners, inventors, patent attorneys, patent agents, etc.). An internal quality control team (e.g., the QC group 1504 of FIG. 15) of the network of patent attorneys may be provided to monitor and/or manage adherence to the uniform best practice per technology area methodology. The uniform best practice per technology area methodology may be revised periodically based on judicial action, legislative action, discontinuity and/or regulatory action affecting the best practice methodology.

A governmental privilege may be maintained between a patent attorney and a client through a separate entity 708 by performing the core portion of the patent legal service in the separate entity 708. The governmental privilege may be extended to employees of a foreign jurisdiction entity 402 when performing the task portion under a supervision of the patent attorney. For example, the governmental privilege may be anyone of an attorney client privilege and an attorney work product privilege. Confidentiality may be maintained by the network of patent attorneys to preserve client confidences through a set of purge and segmentation policies which ensure that confidential information does not escape a privileged workgroup formed between the patent attorneys and the foreign jurisdiction entity 402.

A patent attorney may be recruited (e.g., using the recruiting module 310) from an external network when the patent attorney has an independent client base above a threshold value. Endemic services may be provided in the holistic patent services support solution including patent paralegal support, engineer allocation, patent engineer allocation in a foreign jurisdiction, patent agent allocation in the foreign jurisdiction, search specialist allocation, docketing clerk allocation in the foreign jurisdiction, and/or patent illustrator allocation in the foreign jurisdiction, etc.

Patent support services may be provided in the holistic patent services support solution including organization formation service, real estate service, office management service, training service, marketing collaboration service, a recruiting service, marketing cooperative service, advertising cooperative service, professional website creation service, billing service, accounting service, matter management service, consulting service, and/or collections service, etc.

In another embodiment, providing the holistic professional support solution may include segmenting (e.g., using the segmentation module 320) a task portion of a professional service from a core portion of a professional service based on a skill level required to perform the task portion and the core portion and a quality benchmark of the task portion of the professional service may be improved by performing the task portion in a foreign jurisdiction entity 402 where a foreign labor rate permits the task portion to be dedicated additional time in a given budget. A corporate ownership interest as stock options may be provided to client-facing professionals 706 based on origination revenue, objective quality-benchmark of work product, tenure, and/or client feedback rating of the client-facing professional 706.

For example, employees of the foreign jurisdiction entity 402 who display exceptional skill in performing the task portion of the professional service may provide an incentive to become a client-facing professional 706 in a primary jurisdiction through an educational opportunity reimbursement in the primary jurisdiction and a work status sponsorship in the primary jurisdiction. A governmental privilege may be maintained between the client-facing professional 706 and a client through the separate entity 708 by performing the core portion of the professional service in the separate entity 708.

Further, the governmental privilege may be extended to the employees of the foreign jurisdiction entity 402 when performing the task portion under a supervision of the client-facing professional 706. For example, the governmental privilege may be anyone of an attorney client privilege and an attorney work product privilege. Confidentiality may be maintained by the professional service network to preserve client confidences through a set of purge and segmentation policies that ensure that confidential information does not escape a privileged workgroup formed between the client-facing professional 706 and the foreign jurisdiction entity 402.

In addition, a client-facing professional 706 may be recruited (e.g., through the recruiting module 310 of FIG. 3) from an external entity (e.g., the external entity 704 of FIG. 7) when the client-facing professional 706 has an independent client base above a threshold value. Endemic services may be provided in the holistic professional support solution including a paralegal support, an apprentice allocation in a foreign jurisdiction, an illustrator allocation in the foreign jurisdiction, and/or an engineer allocation in the foreign jurisdiction, etc.

Support services may be provided in the holistic professional support solution including organization formation service, real estate service, office management service, training service, marketing collaboration service, a recruiting service, marketing cooperative service, advertising cooperative service, professional website creation service, billing service, accounting service, matter management service, consulting service, and/or collections service, etc.

In some embodiment, a task portion of the professional service may be performed through a foreign jurisdiction entity 402 where a foreign labor rate permits the task portion to be dedicated additional time in given budget and a client confidence may be preserved through a set of policies that ensure that a confidential information does not escape a privileged workgroup formed between the client-facing professional 706 of the separate entity 708 and a partitioned team of the foreign jurisdiction entity 402.

The central organization (e.g., central entity 404 of FIG. 4) may be located in a jurisdiction selected based on writing skill profile, an education profile, infrastructural profile, judicial precedent profile, political profile, labor cost profile, language proficiency profile, economic profile, cultural profile, and/or special expertise profile of the jurisdiction, etc.

FIG. 4 is a global system view of the enabled network of the independent professional entities of FIG. 1, according to one embodiment. Particularly, FIG. 4 illustrates an entity interaction view 401A and an entity distribution view 401B, according to one embodiment. The entity interaction view 401A displays an enabling entity 400A (e.g., associated with the enabling module 100 of FIG. 1), a central entity 402A (e.g., associated with the central module 106 of FIG. 1), entities 404A (e.g., the separate entities 102 A-B associated with a client-facing professional 706 of the professional service network illustrated in FIG. 1), an entity 406 (e.g., an entity 104 associated with the client-facing professional 706 of the professional service network illustrated in FIG. 1), clients 408A-B, and a client 410.

The entity distribution view 401B may represent a simplified view of interactions between an enabling entity 400B, a central entity 402B, various entities 404N and/or clients 408N.

The entity interaction view 401A illustrates two example interactions. In the first example interaction, a client-facing professional 706 (e.g., an engineer, an attorney, an accountant, and/or a specialist, etc.), may have established a client relationship with the client (e.g. the client 408A, the client 408B and/or certain ones of the clients 408N) prior to joining the professional service network (e.g., the network of separate entities 102 A-B and/or separate entities 104 A-B illustrated in FIG. 1) as the entity 404 (e.g., the entity 404A, the entity 404B, and/or certain ones of the entities 404N) as illustrated in the entity interaction view 401A.

In the second example interaction, the client-facing professional 706 may not have established the client relationship with the client 410 prior to joining the professional service network as the entity 406 (e.g., certain ones of the entities 404N). The enabling entity 400 may facilitate a transfer of a workflow from the client 410 to the separate entity 406 located in a foreign jurisdiction as illustrated in the entity interaction view 401A.

The entity distribution view 401B illustrates an example of global distribution of the enabling entity 400B, the central entity 402B, the separate entities 404N and the clients 408N. The separate entities 404N may be geographically dispersed, and/or may be distributed densely or sparsely in any one region. In one embodiment, multiple branch entities of the enabling entity 400 may be geographically dispersed (e.g., may be located in different regional and/or global locations so that they may be proximal to various distribution networks of the separate entities 404A-N).

The central entity 402 may be a foreign jurisdiction entity (e.g., may be foreign relative to a location of the enabling entity 400 and/or the separate entities 404A-N of the professional service network). The central entity 402B may be dispersed at any location in order to facilitate easy delivery of work products from client-facing professionals 706 of separate entity 404N to the clients 408N.

In one embodiment, the foreign jurisdiction entity 402 may be qualified as a franchised entity of the network of patent attorneys based on a conformance with a particular portion of the uniform best practice per technology area methodology. In another embodiment, the foreign jurisdiction entity 402 may be qualified as a franchised entity of a professional service network based on a conformance with a particular portion of the uniform best practice per technology area methodology.

FIG. 5 is a table view of data referenced by the account database 220 of FIG. 2, according to one embodiment. Particularly, FIG. 5 illustrates a professional name field 502, a location field 504, a client book field 506, a book value field 508, unoriginated clients field 510, a total book value field 512, a contract code field 514, an annual revenue field 516, a management fee field 518 and a technology area field 520, according to one embodiment. The professional name field 502 may display an identifier referencing the identity of a professional (e.g., the client-facing professional 706 of the separate entity 708 illustrated in FIG. 7).

The location field 504 may display an identifier associated with a location (e.g., a geographical reference) of a separate entity 708 associated with the client-facing professional 706. The client book field 506 may display identifiers associated with accounts of clients 108A-B of a separate entity 708 associated with the client-facing professional 706 of the professional service network. The book value field 508 may display a value associated with bills likely to be payable of all the clients 108 A-B referenced in the client book field 506.

The unoriginated clients field 510 may display identifiers associated with clients 110 of the separate entity 708 of the client-facing professional 706 of the professional service network who provides referral to the clients 108 A-B. The total book value field 512 may display a value associated with a sum of the book value.

The contract code field 514 may display identifier referencing a contract agreement between the separate entity 102, the separate entity 104 and the enabling module 100. The annual revenue field 516 may display a value of an actual revenue realized by the separate entity 708 associated with the client-facing professional 706.

The management fee field 518 may display value of a sharing of annual revenue of the separate entity 708 associated with the client-facing professional 706 payable to the enabling entity 400. The technology area field 520 may display identifiers associated with technology areas (e.g., mechanical, electrical, electronics, computer science, biomedical, etc.) in which the client-facing professional 706 of the separate entity 708 has served one or more LLPs.

For example, two hypothetical client-facing professionals 706 are illustrated in account table 500 of FIG. 5. The professional name field 502 displays ‘John Smith, John Smith LLP’ and ‘Jane Doe, Law Offices of Jane Doe,’ indicating the professional name and the entity. The location field 504 displays ‘265 Oak RD, Fremont, Calif.,’ and ‘99 44^{th} St, Atlanta, Ga.,’ indicating that ‘John Smith’ of the entity ‘John Smith LLP’ is located at ‘265 Oak Rd, Fremont, Calif.,’ and that ‘Jane Doe’ of the entity ‘Law Offices of Jane Doe’ is located at ‘99 44^{th} St, Atlanta, Ga.’ The client book field 506 displays ‘A, B, C, D’ indicating ‘John Smith's' clients, and ‘N/A,’ indicating that ‘Jane Doe’ has no clients of his/her own.

The book value field displays ‘$1 m’ and ‘$0’ indicating that value of ‘John Smith's' clients is ‘$1 m,’ and that as ‘Jane Doe’ has no clients, his book value is ‘$0.’ The unoriginated clients field 510 displays ‘N/A’ and ‘X,Y, Z’ indicating that ‘John Smith’ did not get any clients through referrals from other client-facing professionals 706 in the professional service network, and that ‘Jane Doe’ was referred the clients ‘X, Y, Z’.

The total book value field 512 displays ‘$1 m’ and ‘$0.8 m,’ indicating that the total value of all ‘John Smith's' client books is ‘$1 m,’ and that the total value of all ‘Jane Doe's’ client books is ‘$0.8 m.’ The contract code field 514 displays ‘3ZX’ and ‘INGA’, indicating the relationship between the separate entities 708 associated with both client-facing professionals 706 and the enabling entity 400.

The annual revenue field 516 displays ‘$1.3 m,’ and ‘$0.75 m’ indicating that the annual revenue associated with ‘John Smith's LLP’, and ‘$0.75 m,’ indicating the annual revenue associated with ‘Law Offices of Jane Doe’. The management fee field 518 displays ‘$650 k’ and ‘$0.3 m,’ indicating the value provided by ‘John Smith’ and ‘Jane Doe’ respectively to the enabling entity 400 as management fees. The technology area field 520 displays ‘EE, Mech, Ent. Software’ and ‘Gen. Networks, EE,’ indicating that John Smith administer work in the technology areas of electrical engineering, mechanical engineering and enterprise software, while Jane Doe administer work in the technology areas of general technology, networks, and electrical engineering.

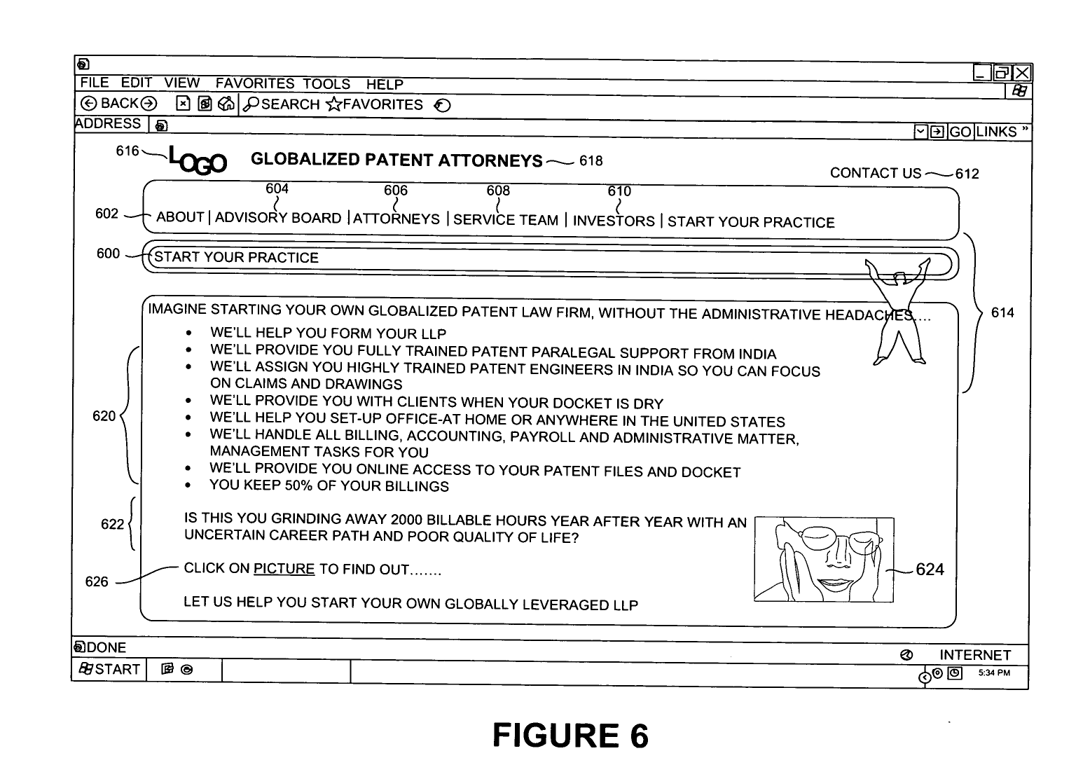

FIG. 6 is a user interface view of the marketing module 224 of FIG. 2, according to one embodiment. Particularly, FIG. 6 illustrates a start your practice link 600, an about link 602, an advisory board link 604, an attorneys link 606, a service team link 608, an investors link 610, a contact us link 612, a page graphics view 614, a logo view 616, a caption view 618, a reasons view 620, a query view 622, a query graphics view 624 and a call to action view 626, according to one embodiment.

For example, the about link 602 may reference information on a structure of the professional service network. The advisory board link 604 may reference further information associated with the advisory board. The attorney link 606 may provide information about patent attorneys of a separate entity 708. The service team link 608 may reference information associated with team of the professional service network of a foreign jurisdiction entity 402 associated with the central module 106. The investors link 610 may reference information about partners, shareholders of the organization 1400.

The contact us link 612 may offer information that may allow a user to contact professionals (e.g., corporate owner, marketing personnel, attorney, investor, etc.) to seek additional information required. The page graphics view 614 may display a marketing message associated with the marketing module 224. The logo view 616 may display a logo of a corporate entity associated with the marketing message of the enabling module 100 and/or of the professional service network. The caption view 618 may display a caption having importance to a user viewing the marketing message. The reason view 620 displays information that targets service and/or quality provided to the user looking forward for investment.

The query view 622 may display textual information that targets the user willing to join the professional service network. The query graphics view 624 may display an image targeted to the user interested in joining the professional service network and who may be worried of acquiring best quality services. The caption view 626 may display caption targeted to convince the user to join the separate entity 708 of the professional service network of enabling module 100 and/or the central module 106.

FIG. 7 is a chart view of a revenue distribution comparison between an independent entity and an external entity, according to one embodiment. Particularly, FIG. 7 illustrates an external distribution chart 700, an enabling entity distribution chart 702, an external entity 704, a client-facing professional 706, a separate entity 708, an enabling share 710, a firm share 712, a professional share 714, a professional share 716, cost of services 718 and cost of services 720, according to one embodiment.

The external distribution chart 700 may symbolize a distribution of revenue generated by the client-facing professional 706 associated with an entity 704 (e.g., a firm, a support centre, a professional service centre, etc.) external to a professional service network.

The external distribution chart 700 may be a diagram, plan, graph representation, a visual aid that may represent distribution of different percentage of revenue shares for different categories (e.g., professional share, cost of services, firm share, etc.) in the professional service network generated from the client-facing professional 706 of the external entity 704. The enabling entity distribution chart 702 may be diagram, plan, graph representation, visual aid that may represent distribution of different percentage of revenue shares for different categories (e.g., professional share, cost of services, enabling share, etc.) in the professional service network (e.g., the enabling network of independent entities) generated from the client-facing professional 706 of the separate entity 708.

The external entity 704 may be a part of the professional service network. The client-facing professional 706 may be associated with the professional service network of the central module 106 that may render services to different LLPs through the enabling module. The separate entity 708 may also contain client-facing professionals 706 that may generate revenue through a service (e.g., a patent legal service, a professional service, etc.) provided to different firms linked with the enabling module 100.

The enabling share 710 may be a share of the enabling entity 400 associated with the network (e.g., a professional service network, a network of patent attorneys, etc.) of separate entities 708. The firm share 712 may be a share receivable by partners, associates, corporate owners, etc. The professional shares 714 and 716 may be shares of the client-facing professionals 706 of the separate entity 708 and the external entity 704 respectively. The cost of services 718 and 720 may be cost associated with the services performed by the client-facing professional 706 of the external entity 704 and the separate entity 708 respectively.

In the example embodiment illustrated in FIG. 7, the external distribution chart 700 displays three segments including the professional share 716, the firm share 712 and the cost of services 718. The professional share 716 displays ‘30%,’ indicating that the client-facing professional 706 of the external entity 704 receives 30% of a revenue generated by the client-facing professional 706.

The firm share 712 displays ‘35%,’ indicating that the firm (e.g., corporate owners, shareholders, investors, etc.) of the external entity 704 receives 35% of the revenue generated by the client-facing professional 706. The cost of services 718 displays ‘35%,’ indicating that the cost of services (e.g., labor cost, maintenance cost, support service cost, etc.) performed by the client-facing professional 706 of the external entity 704 is 35%.

The enabling entity distribution chart 702 displays three segments including the professional share 714, the enabling share 710 and the cost of services 720. The professional share 714 displays ‘50%,’ indicating that the client-facing professional 706 of the separate entity 708 receives 50% of a revenue generated by the client-facing professional 706

The enabling share 710 displays ‘40%,’ indicating that the enabling entity 400 associated with the network of separate entities 708 receives 40% of the revenue generated by the client-facing professional 706. The cost of services 720 displays ‘10%,’ indicating that the cost of services performed by the client-facing professional 706 of the separate entity 708 is 10%.

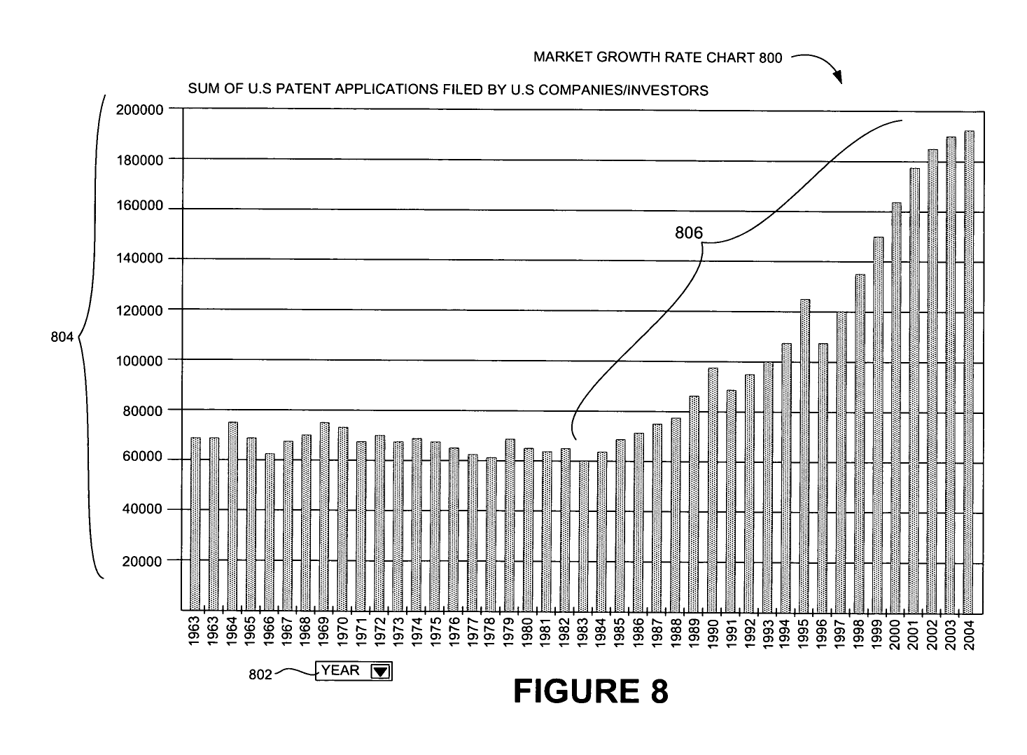

FIG. 8 is a market growth rate chart 800 of a work product relevant to an independent entity, according to one embodiment. Particularly, FIG. 8 illustrates X-axis 802, Y-axis 804 and an upward trend 806, according to one embodiment. The X-axis 802 may display units of time (e.g., years) for a period of coverage of the market growth rate chart 800 (e.g., 1963 to 2004). The Y-axis 804 may display units of measurement (e.g., in unit increments of 20000) indicating a ‘Sum of US Patent applications filed by US companies/inventors' with respect to each unit of time displayed on the Y-axis 804.

The upward trend 806 displays a cumulative increase in (e.g., an increasing trend) the ‘Sum of US patent applications filed by U.S. Companies/inventors’ on the Y-axis 804 over a period of time of about 20 years. For example, market growth rate chart 800 indicates that the US patent application filing activity by the US companies/investors in the recent past has been increased in the US region and/or also may reveal that there may be a scope for expansion for this kind of activity in future.

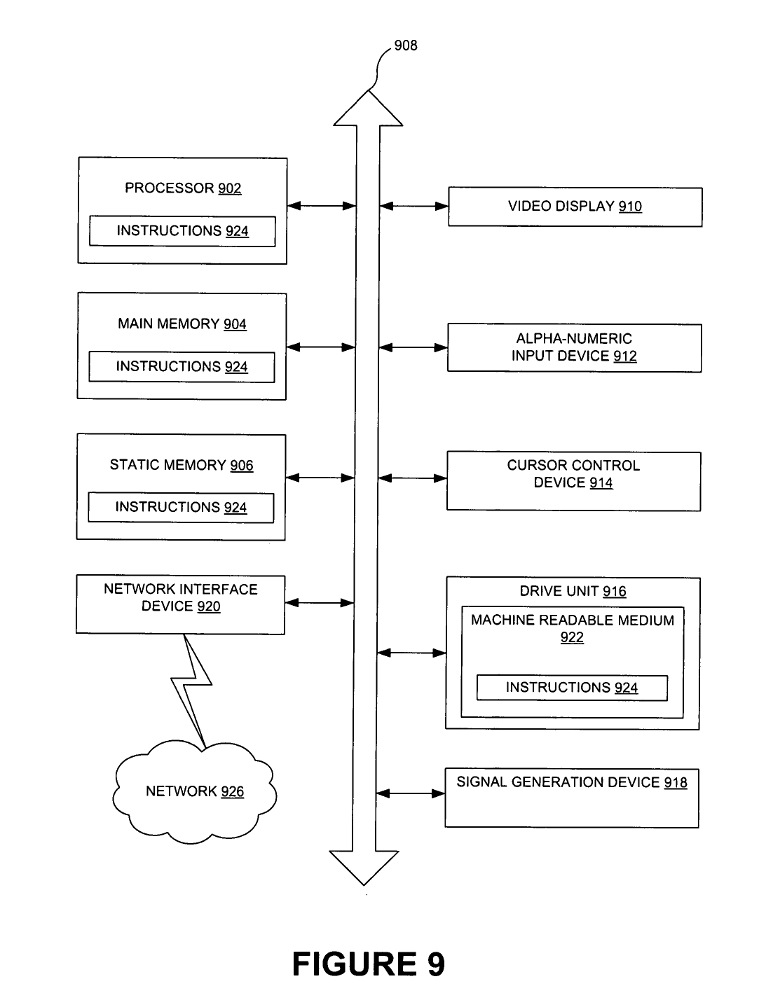

FIG. 9 is a diagrammatic system view 900 of a data processing system in which any of the embodiments disclosed herein may be performed, according to one embodiment. Particularly, the diagrammatic system view 900 of FIG. 9 illustrates a processor 902, a main memory 904, a static memory 906, a bus 908, a video display 910, an alpha-numeric input device 912, a cursor control device 914, a drive unit 916, a signal generation device 918, a network interface device 920, a machine readable medium 922, instructions 924 and a network 926, according to one embodiment.

The diagrammatic system view 900 may indicate a personal computer and/or a data processing system in which one or more operations disclosed herein are performed. The processor 902 may be microprocessor, a state machine, an application specific integrated circuit, a field programmable gate array, etc. (e.g., Intel® Pentium® processor). The main memory 904 may be a dynamic random access memory and/or a primary memory of a computer system.

The static memory 906 may be a hard drive, a flash drive, and/or other memory information associated with the data processing system. The bus 908 may be an interconnection between various circuits and/or structures of the data processing system. The video display 910 may provide graphical representation of information on the data processing system. The alpha-numeric input device 912 may be a keypad, keyboard and/or any other input device of text (e.g., special device to aid the physically handicapped). The cursor control device 914 may be a pointing device such as a mouse.

The drive unit 916 may be the hard drive, a storage system, and/or other longer term storage subsystem. The signal generation device 918 may be a bios and/or a functional operating system of the data processing system. The network interface device 920 may be a device that may perform interface functions such as code conversion, protocol conversion and/or buffering required for communication to and from a network.

The machine readable medium 922 may provide instructions on which any of the methods disclosed herein may be performed. The instructions 924 may provide source code and/or data code to the processor 902 to enable any one or more operations disclosed herein.

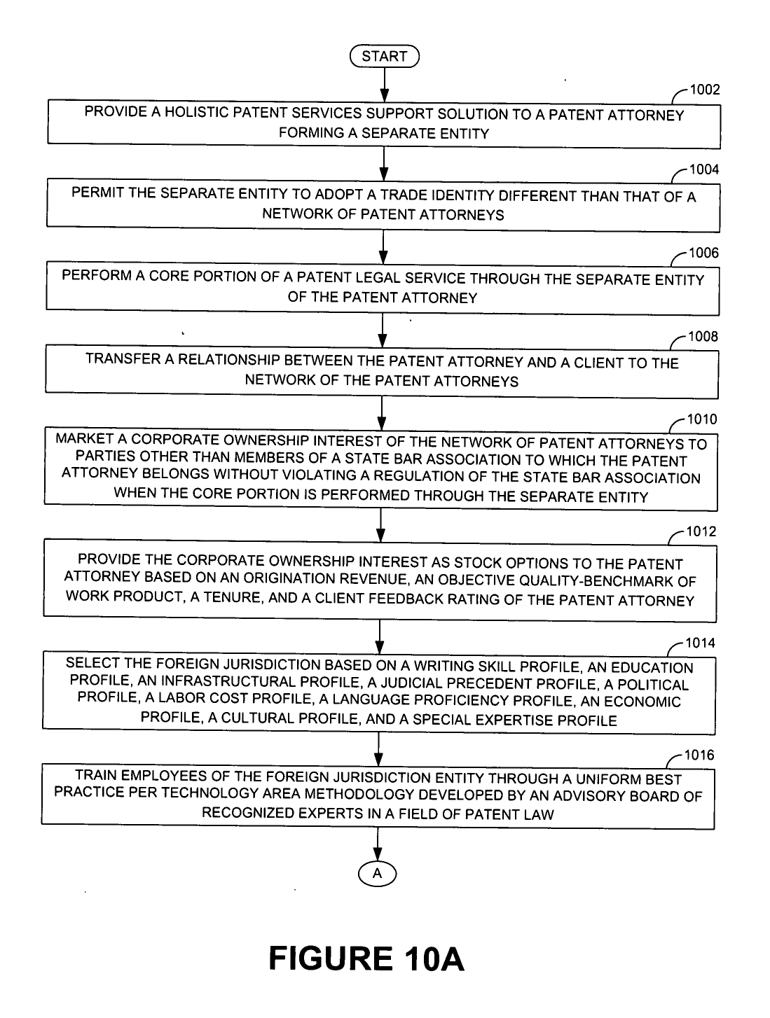

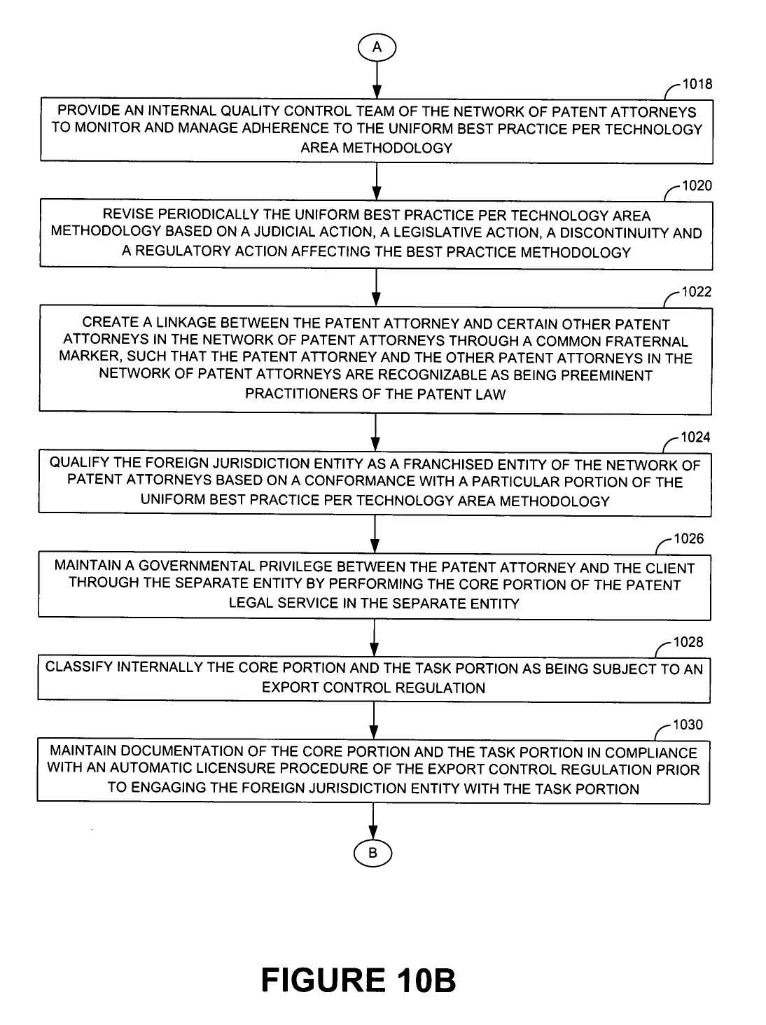

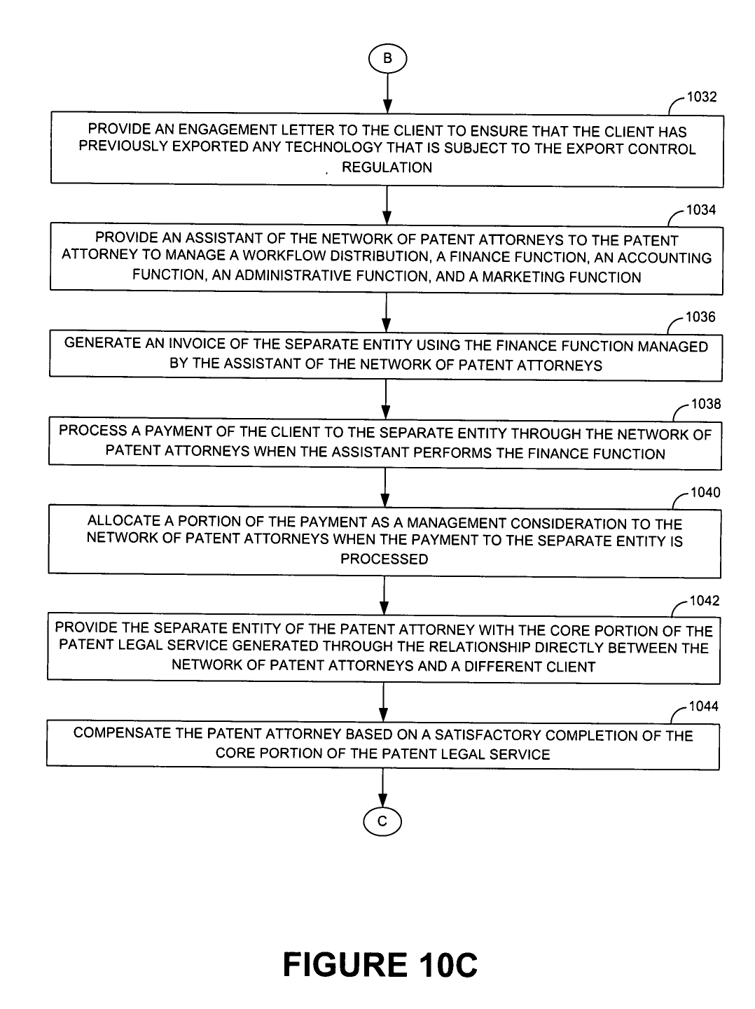

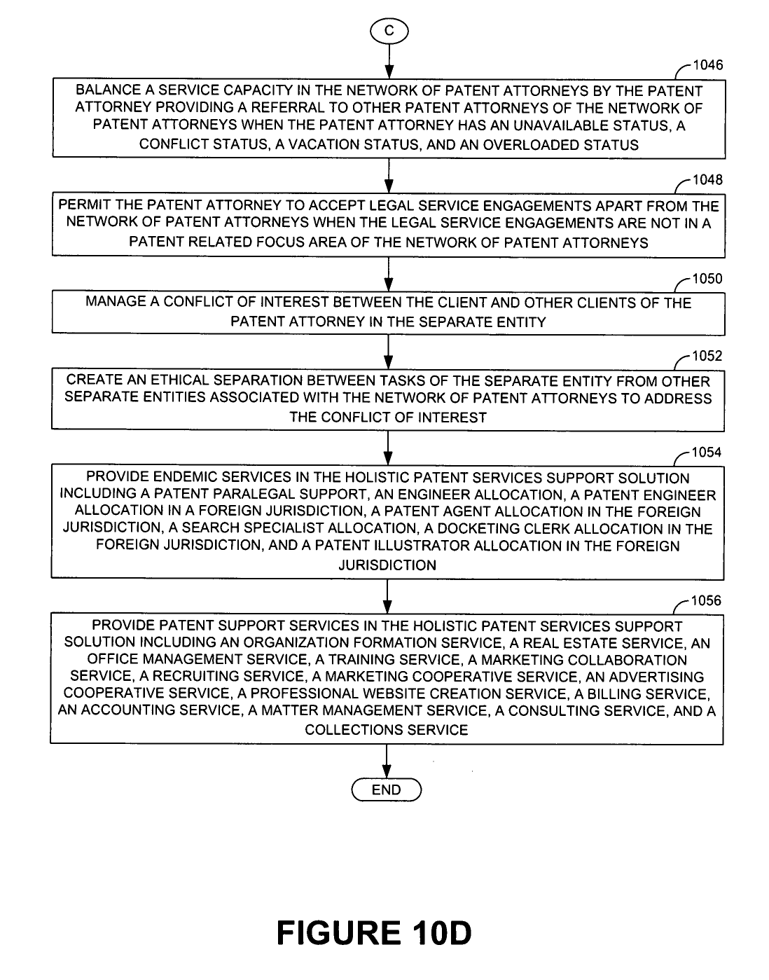

FIG. 10A is a process flow of providing patent legal services to a patent attorney forming a separate entity 708, according to one embodiment. In operation 1002, a holistic patent services support solution (e.g., of services endemic and/or auxiliary to a focus area) may be provided to the patent attorney forming the separate entity 708 (e.g., a private practice a partnership, etc., associated with the enabling module 100 of FIG. 1).

In operation 1004, the separate entity 708 may be permitted to adopt a trade identity different than that of a network of patent attorneys (e.g., a network of independent entities 102 A-B associated with the enabling module 100). In operation 1006, a core portion of a patent legal service (e.g., segmented from a task portion based on a skill level required to perform the core portion and the task portion) may be performed through the separate entity 708 of the patent attorney. In operation 1008, a relationship between the patent attorney and a client (e.g., the client 108 of FIG. 1) may be transferred to the network of patent attorneys.

In operation 1010, a corporate ownership interest (e.g., a corporate equity) of the network of patent attorneys may be marketed (e.g., through the enabling module 100) to parties other than members of a State Bar Association to which the patent attorney belongs without violating a regulation of the State Bar Association when the core portion is performed through the separate entity 708. In operation 1012, the corporate ownership interest may be provided as stock options to the patent attorney (e.g., based on an origination revenue, an objective quality-benchmark of work product, a tenure, and/or a client feedback rating of the patent attorney, etc.).

In operation 1014, a foreign jurisdiction (e.g., associated with the central module 106 of FIG. 1) may be selected based on a writing skill profile, an education profile, an infrastructural profile, a judicial precedent profile, a political profile, a labor cost profile, a language proficiency profile, an economic profile, a cultural profile, and/or a special expertise profile, etc. In operation 1016, employees (e.g., and/or contractors) of the foreign jurisdiction entity 402 may be trained through a uniform best practice per technology area methodology developed by an advisory board (e.g., associated with the advisory module 112 of FIG. 1) of recognized experts in a field of patent law (e.g., patent agents, patent attorneys, examiners, inventors, etc.).

FIG. 10B is a continuation of the process flow of FIG. 10A, illustrating additional processes, according to one embodiment. In operation 1018, an internal quality control team (e.g., the QC group 1504 of FIG. 15) of the network of patent attorneys may be provided (e.g., using the QC module 230 of FIG. 2) to monitor and/or manage adherence to the uniform best practice per technology area methodology. In operation 1020, the uniform best practice per technology area methodology may be periodically revised (e.g., based on a judicial action, a legislative action, a discontinuity and/or a regulatory action affecting the best practice methodology).

In operation 1022, a linkage may be created between the patent attorney and certain other patent attorneys in the network of patent attorneys through a common fraternal marker (e.g., such that the patent attorney and the other patent attorneys in the professional service network are recognizable as being preeminent practitioners in their professions). In operation 1024, the foreign jurisdiction entity 402 may be qualified as a franchised entity of the network of patent attorneys based on a conformance with a particular portion of the uniform best practice per technology area methodology.

In operation 1026, a governmental privilege may be maintained between the patent attorney and the client (e.g., using the control module 210 of FIG. 2) through the separate entity 708 by performing the core portion of the patent legal service in the separate entity 708. In operation 1028, the core portion and/or the task portion may be internally classified as being subject to an export control regulation. In operation 1030, Documentation of the core portion and/or the task portion may be maintained (e.g., using the tracking module 218 of FIG. 2) in compliance with an automatic licensure procedure of the export control regulation prior to engaging the foreign jurisdiction entity 402 (e.g., associated with the central module 106 of FIG. 1) with the task portion.

FIG. 10C is a continuation of the process flow of FIG. 10B, illustrating additional processes, according to one embodiment. In operation 1032, an engagement letter may be provided to the client (e.g., the client 108 of the patent attorney associated with the separate entity 102) to ensure that the client has previously exported any technology that is subject to the export control regulation.

In operation 1034, an assistant of the network of patent attorneys may be provided (e.g., using the service module 236 of FIG. 2) to the patent attorney (e.g., to manage workflow distribution, finance function, accounting function, administrative function, and/or marketing function, etc.).

In operation 1036, an invoice of the separate entity 708 may be generated using the finance function (e.g., through the billing module 216 of FIG. 2) managed by the assistant of the network of patent attorneys (e.g., based on a communication with the professional module 204 of FIG. 2). In operation 1038, a payment of the client (e.g., using the financial module 206 of FIG. 2) to the separate entity 708 may be processed through the network of patent attorneys (e.g., when the assistant performs the finance function). In operation 1040, a portion of the payment may be allocated as a management consideration to the network of patent attorneys (e.g., by the management fee module 242 of FIG. 2) when the payment to the separate entity 708 is processed.

In operation 1042, the separate entity 708 of the patent attorney may be provided with the core portion of the patent legal service generated through a relationship directly between the network of patent attorneys and a different client (e.g., using the sales module 246 of FIG. 2). In operation 1044, the patent attorney may be compensated based on a satisfactory completion of the core portion of the patent legal service.

FIG. 10D is a continuation of the process flow of FIG. 10C, illustrating additional processes, according to one embodiment. In operation 1046, a service capacity may be balanced in the network of patent attorneys by the patent attorney providing a referral to other patent attorneys (e.g., through the capacity balancing module 238 of FIG. 2) of the network of patent attorneys (e.g., when the patent attorney has an unavailable status, a conflict status, a vacation status, and/or an overloaded status, etc.)

In operation 1048, the patent attorney may be permitted to accept legal service engagements apart from the network of patent attorneys when the legal service engagements are not in a patent related focus area of the network of patent attorneys (e.g., based on an analysis performed by the conflict analyzer 214 of FIG. 2). In operation 1050, a conflict of interest between the client and other clients of the patent attorney may be managed in the separate entity 708 (e.g., by the control module 210 of FIG. 2).

In operation 1052, an ethical separation may be created between tasks of the separate entity 708 from other separate entities 708 associated with the network of patent attorneys to address the conflict of interest. In operation 1054, endemic services (e.g., including a patent paralegal support, an engineer allocation, an patent engineer allocation in a foreign jurisdiction, an patent agent allocation in the foreign jurisdiction, a search specialist allocation, a docketing clerk allocation in the foreign jurisdiction, and/or patent illustrator allocation in the foreign jurisdiction, etc.) may be provided in the holistic patent services support solution.

In operation 1056, patent support services (e.g., may include an organization formation service, a real estate service, an office management service, a training service, a marketing collaboration service, a recruiting service, a marketing cooperative service, an advertising cooperative service, a professional website creation service, a billing service, an accounting service, a matter management service, a consulting service, a billing service, and/or a collections service, etc.) may be provided in the holistic patent services support solution.

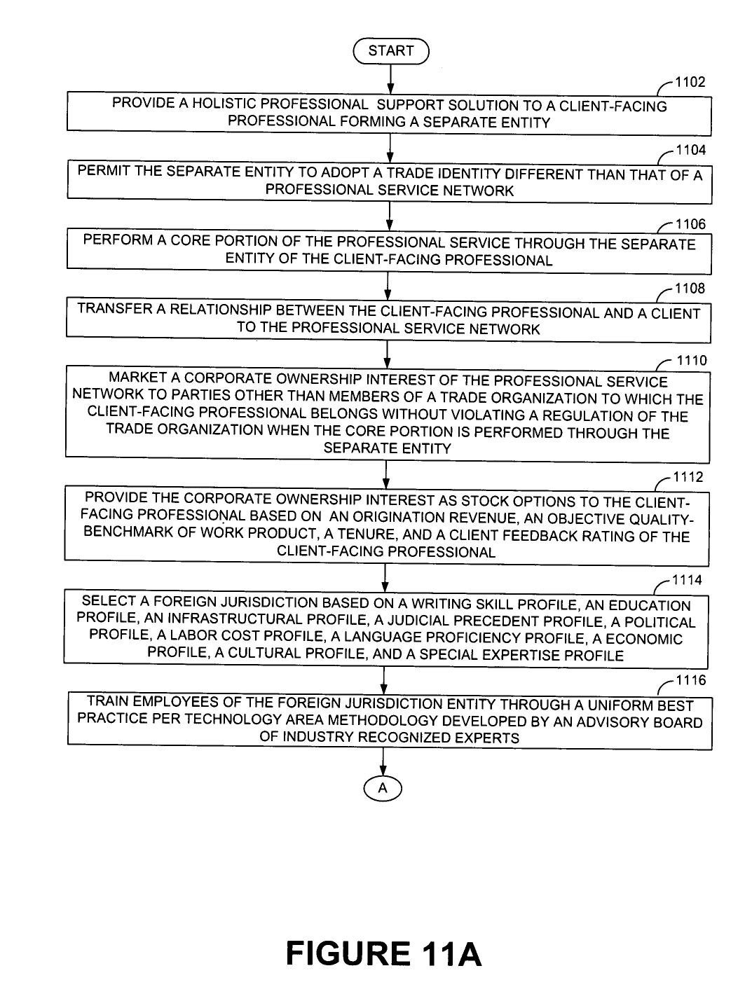

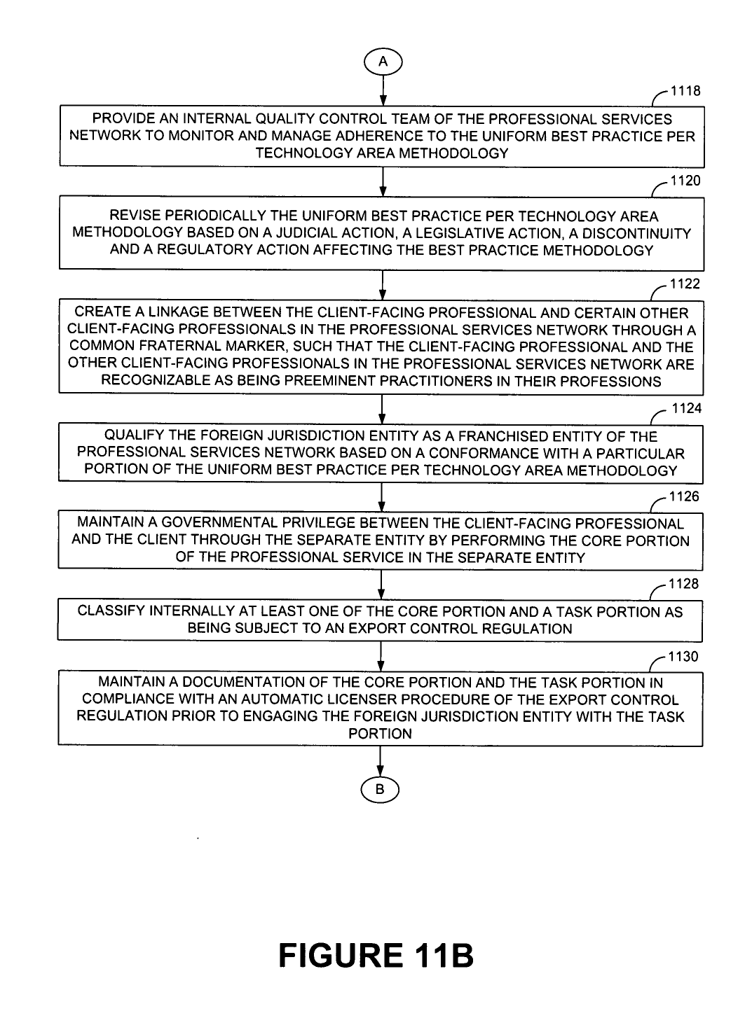

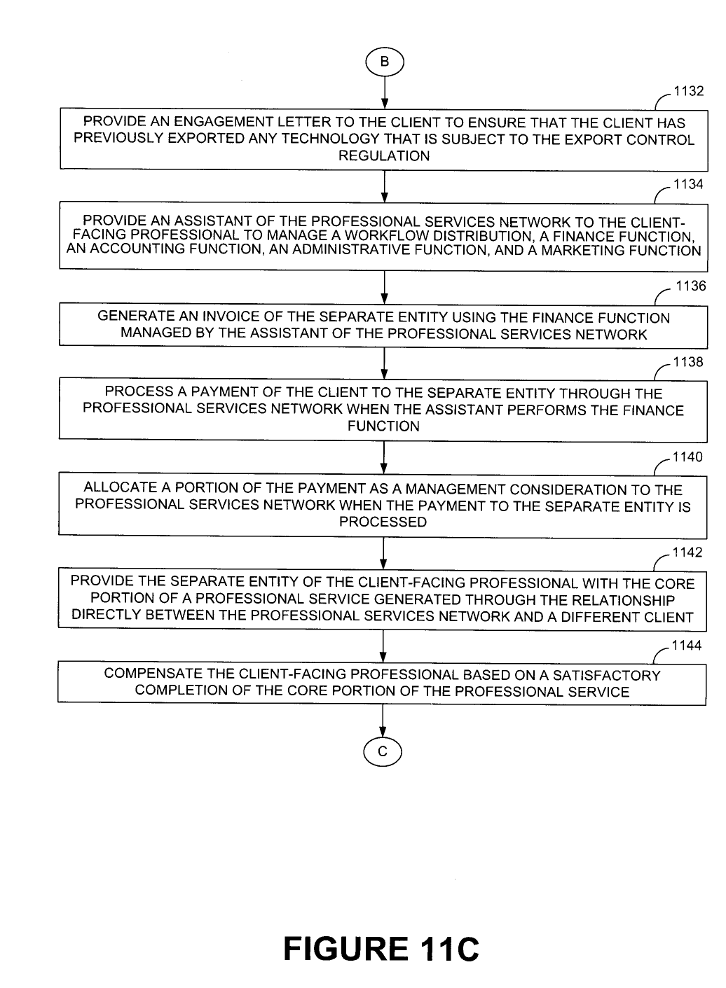

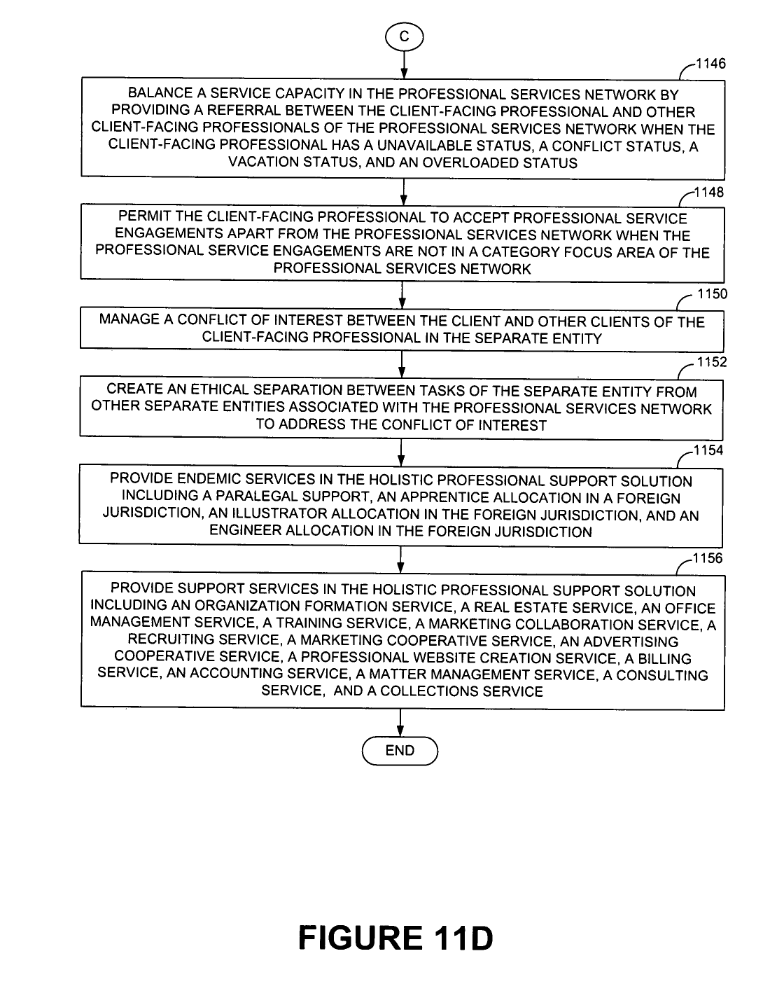

FIG. 11A is a process flow of providing professional services to a client-facing professional 706 forming a separate entity 708, according to one embodiment. In operation 1102, a holistic support solution (e.g., of services endemic and/or auxiliary to a focus area) may be provided to the client-facing professional 706 (e.g., an attorney, a consultant, a doctor, an accountant, an architect, etc.) forming the separate entity 708 (e.g., a private practice, a partnership, etc., associated with the enabling module 100 of FIG. 1).

In operation 1104, the separate entity 708 may be permitted to adopt a trade identity different than that of a professional service network (e.g., a network of independent entities 108 A-B associated with the enabling module 100). In operation 1106, a core portion of a professional service (e.g., segmented from a task portion based on a skill level required to perform) may be performed through the separate entity 708 of the client-facing professional 706. In operation 1108, a relationship between the client-facing professional 706 (e.g., of the separate entity 708 of FIG. 7) and a client (e.g., the client 108 of FIG. 1) may be transferred to the professional service network.

In operation 1110, a corporate ownership interest (e.g., a corporate equity) of the professional service network may be marketed (e.g., through the enabling module 100) to parties other than members of a trade organization (e.g., a State Bar Association) to which the client-facing professional 706 belongs without violating a regulation of the trade organization when the core portion is performed through the separate entity 708. In operation 1112, the corporate ownership interest may be provided as stock options to the client-facing professional 706 (e.g., based on an origination revenue, an objective quality-benchmark of work product, a tenure, and/or a client feedback rating of the client-facing professional 706, etc.).

In operation 1114, a foreign jurisdiction (e.g., associated with the central module 106 of FIG. 1) may be selected based on a writing skill profile, an education profile, an infrastructural profile, a judicial precedent profile, a political profile, a labor cost profile, a language proficiency profile, an economic profile, a cultural profile, and/or a special expertise profile, etc. In operation 1116, employees (e.g., and/or contractors) of the foreign jurisdiction entity 402 may be trained through a uniform best practice per technology area methodology developed by an advisory board (e.g., associated with the advisory module 112 of FIG. 1) of industry recognized experts (e.g., patent agents, examiners, inventors, attorneys, etc.).

FIG. 11B is a continuation of the process flow of FIG. 11A, illustrating additional processes, according to one embodiment. In operation 1118, an internal quality control team (e.g., the QC group 1504 of FIG. 15) of the professional service network may be provided (e.g., using the QC module 230 of FIG. 2) to monitor and/or manage adherence to the uniform best practice per technology area methodology. In operation 1120, the uniform best practice per technology area methodology may periodically be revised (e.g., based on a judicial action, a legislative action, a discontinuity and/or a regulatory action affecting the best practice methodology).

In operation 1122, a linkage may be created between the client-facing professional 706 and certain other client-facing professionals 706 in the professional service network through a common fraternal marker (e.g., such that the client-facing professional 706 and the other client-facing professionals 706 in the professional service network are recognizable as being preeminent practitioners in their professions). In operation 1124, the foreign jurisdiction entity 402 may be qualified as a franchised entity of the professional service network based on a conformance with a particular portion of the uniform best practice per technology area methodology.

In operation 1126, a governmental privilege may be maintained between the client-facing professional 706 and the client (e.g., using the control module 210 of FIG. 2) through the separate entity 708 by performing the core portion of the professional service in the separate entity 708. In operation 1128, the core portion and/or the task portion may be internally classified as being subject to an export control regulation. In operation 1130, Documentation of the core portion and the task portion may be maintained (e.g., using the tracking module 218 of FIG. 2) in compliance with an automatic licensure procedure of the export control regulation prior to engaging the foreign jurisdiction entity 402 (e.g., associated with the central module 106 of FIG. 1) with the task portion.

FIG. 11C is a continuation of the process flow of FIG. 11B, illustrating additional processes, according to one embodiment. In operation 1132, an engagement letter may be provided to the client (e.g., the client of the client-facing professional 706 associated with the separate entity 708) to ensure that the client has previously exported any technology that is subject to the export control regulation.

In operation 1134, an assistant of the professional service network may be provided (e.g., using the service module 236 of FIG. 2) to the client-facing professional 706 (e.g., to manage a workflow distribution, a finance function, an accounting function, an administrative function, and/or a marketing function, etc.).

In operation 1136, an invoice of the separate entity 708 may be generated using the finance function (e.g., through the billing module 216 of FIG. 2) managed by the assistant of the professional service network (e.g., based on a communication with the professional module 204 of FIG. 2). In operation 1138, a payment of the client (e.g., using the financial module 206) to the separate entity 708 may be processed through the professional service network when the assistant performs the finance function. In operation 1140, a portion of the payment may be allocated as a management consideration to the professional service network (e.g., by the management fee module 242 of FIG. 2) when the payment to the separate entity 708 is processed.

In operation 1142, the separate entity 708 of the client-facing professional 706 may be provided with the core portion of a professional service generated through a relationship directly between the professional service network and a different client (e.g., using the sales module 246 of FIG. 2). In operation 1144, the client-facing professional 706 may be compensated based on a satisfactory completion of the core portion of the professional service.

FIG. 11D is a continuation of the process flow of FIG. 11C, illustrating additional processes, according to one embodiment. In operation 1146, a service capacity may be balanced in the professional service network by the client-facing professional 706 providing a referral to other client-facing professionals 706 (e.g., through the capacity balancing module 238 of FIG. 2) of the professional service network (e.g., when the client-facing professional 706 has an unavailable status, a conflict status, a vacation status, and/or an overloaded status, etc.)

In operation 1148, the client-facing professional 706 may be permitted to accept professional service engagements apart from the professional service network when the professional service engagements are not in a category focus area of the professional service network (e.g., based on an analysis performed by the conflict analyzer 214 of FIG. 2). In operation 1150, a conflict of interest between the client and other clients of the client-facing professional 706 may be managed in the separate entity 708 (e.g., by the control module 210 of FIG. 2).

In operation 1152, an ethical separation may be created between tasks of the separate entity 708 from other separate entities 708 associated with the professional service network to address the conflict of interest. In operation 1154, endemic services (e.g., including a paralegal support, an apprentice allocation in a foreign jurisdiction, an illustrator allocation in the foreign jurisdiction, and/or an engineer allocation in the foreign jurisdiction, etc.) may be provided in the holistic professional support solution.

In operation 1156, support services (e.g., may include an organization formation service, a real estate service, an office management service, a training service, a marketing collaboration service, a recruiting service, a marketing cooperative service, an advertising cooperative service, a professional website creation service, a billing service, an accounting service, a matter management service, a consulting service, a billing service, and/or a collections service, etc.) may be provided in the holistic professional support solution.

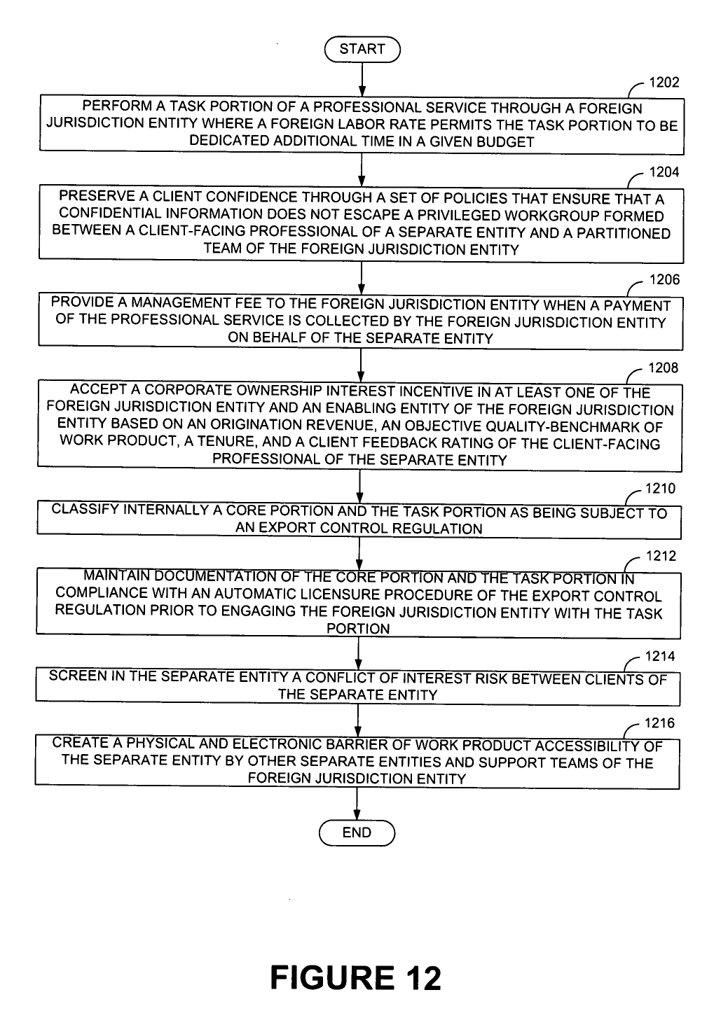

FIG. 12 is a process flow of performing a task portion of a professional service through a foreign jurisdiction entity 402 and preserving a client confidence through a set of policies, according to one embodiment. In operation 1202, the task portion of the professional service may be performed through a foreign jurisdiction entity 402 (e.g., associated with the central module 106 of FIG. 1) where a foreign labor rate permits the task portion to be dedicated additional time in a given budget.

In operation 1204, a client confidence may be preserved through a set of policies (e.g., managed by the control module 210 of FIG. 2) that ensure that the confidential information does not escape the privileged workgroup (e.g., formed between a client-facing professional 706 of a separate entity 708 and a partitioned team of the foreign jurisdiction entity 402). In operation 1206, a management fee may be provided to the foreign jurisdiction entity 402 (e.g., using the management fee module 242 of FIG. 2) when a payment of the professional service may be collected by the foreign jurisdiction entity 402 on behalf of the separate entity 708.

In operation 1208, a corporate ownership interest incentive may be accepted in the foreign jurisdiction entity 402 and/or the enabling entity (e.g., associated with the enabling module 100 of FIG. 1) of the foreign jurisdiction entity 402 (e.g., based on an origination revenue, an objective quality-benchmark of work product, a tenure, and/or a client feedback rating of the client-facing professional 706 of the separate entity 708). In operation 1210, the core portion and/or the task portion may be internally classified as being subject to an export control regulation (e.g., by the tracking module 218 of FIG. 2).

In operation 1212, documentation of the core portion and/or the task portion in compliance with an automatic licensure procedure of the export control regulation may be maintained prior to engaging the foreign jurisdiction entity 402 with the task portion. In operation 1214, a conflict of interest risk between clients 108 A-B of the separate entity 102 (e.g., using the control module 210) may be screened in the separate entity 102. In operation 1216, a physical and/or electronic barrier of work product accessibility of the separate entity 102 may be created (e.g., using the control module 210) by other separate entities 104 A-B and support teams of the foreign jurisdiction entity 402 (e.g., associated with the central module 106 of FIG. 1).

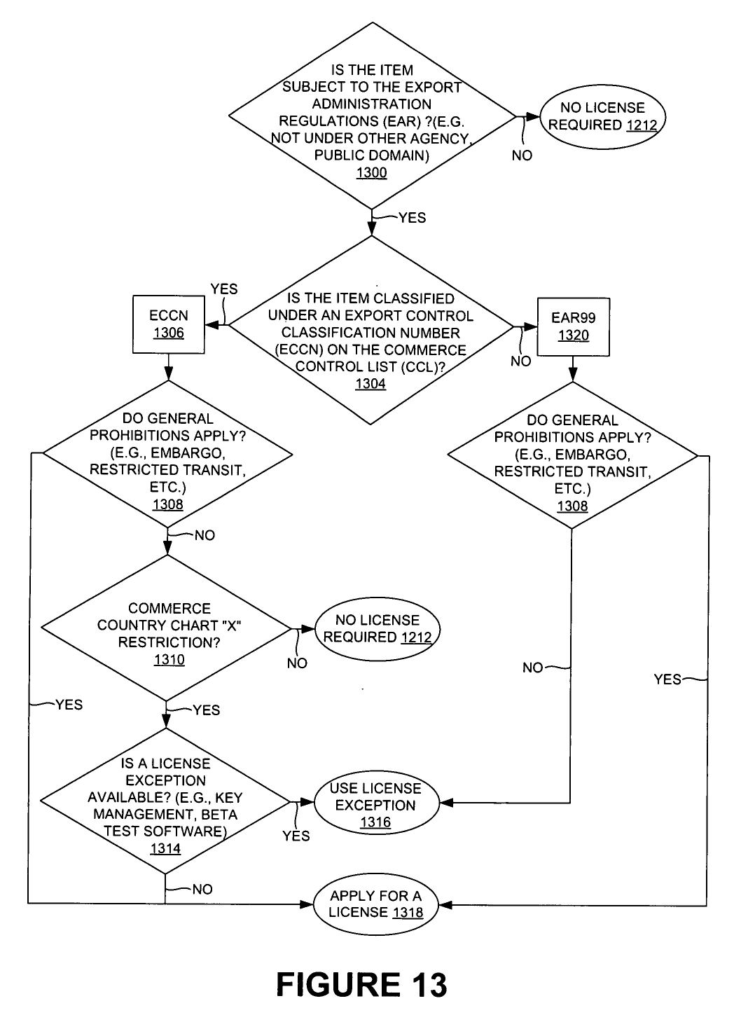

FIG. 13 is a process flow chart to determine a compliance of an item with an export control regulation, according to one embodiment. In operation 1300, it is determined whether the item is subject specifically to Export Administration Regulations (e.g., the item may be subject only to export control regulations under the Bureau of Industry and Security of the United States Department of Commerce, and not under another agency and/or public domain).

In operation 1302, no further determination of compliance may be necessary if the item is not subject to the Export Administration Regulations. In operation 1304, it is determined, whether the item is classified under an Export Control Classification Number on a Commerce Control List (e.g., associated with the United States Department of Commerce) or not. In operation 1306, the item is classified under the Export Control Classification Number (e.g., ECCN).

In operation 1308, it is determined that the item is not classified under the ECCN and is determined to be classified under an “EAR99” classification. (e.g., the item may be classified as being subject to the Export Administration Regulations, but is not listed with a specific Export Control Classification Number (ECCN) on the Commerce Control List of the United States Department of Commerce).

In operation 1310, it is determined whether general prohibitions (e.g., embargo, restricted transit, etc.) apply to the item (e.g., the item classified under the ECCN or the EAR99). In operation 1312, in case, the general prohibitions do not apply to the item, and it is determined whether a commerce country chart “X” restriction applies to the item. In operation 1314, if it is determined that the commerce country chart “X” restrictions do not apply to the item, or general prohibitions do not apply to the item classified under the EAR99, then it is determined that no license is required for the item.

In operation 1316, if the commerce country chart “X” restriction applies to the item, it is determined whether a license exception (e.g., a key management and/or beta test software license exception, etc.) is available for the item or not. In operation 1318, if the general prohibitions apply to the item, or no license exception is available for the item that is subject to the commerce country chart “X” restriction, it is determined that a license has to be applied for (e.g., for export of the item).

In operation 1320, if the license exception is available for the item that is subject to the commerce country chart “X” restriction, it is determined that the license exception for the item is to be used.

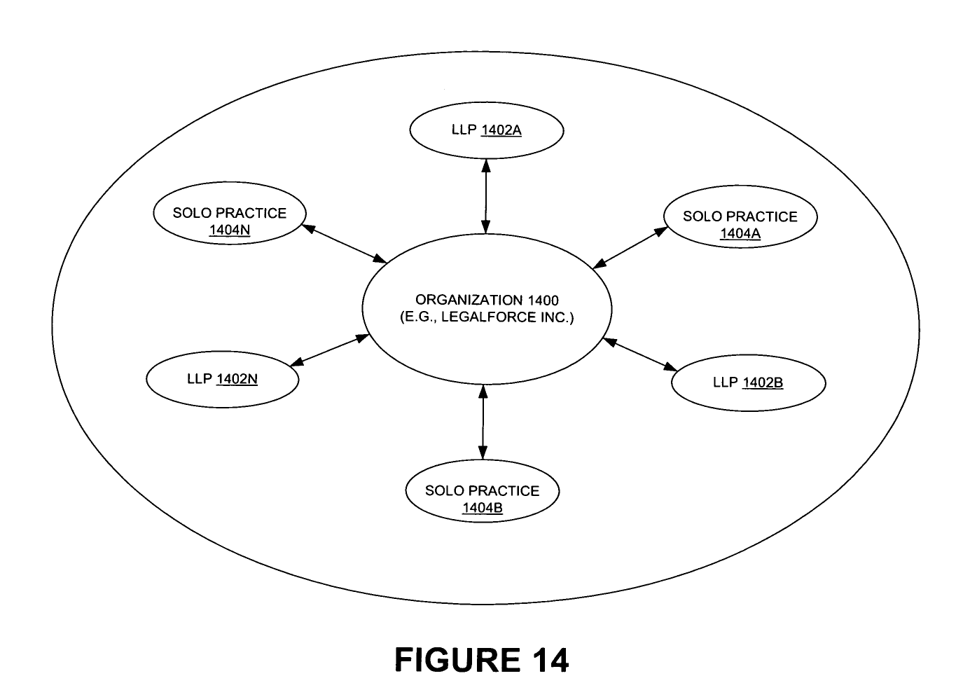

FIG. 14 is a system view of a network of client-facing professionals 706, according to one embodiment. Particularly, FIG. 14 illustrates an organization 1400 (e.g., a corporation such as LegalForce, Inc., a legal services corporation, a patent services corporation, etc.), LLPs 1402A-N (e.g., limited liability partnerships, law firms, patent law firms, etc.) and solo practices 1404A-N (e.g., individual patent attorney practices, patent attorney law firms, etc.), according to one embodiment.

The organization 1400 (e.g., LegalForce, Inc.) may be a corporation providing patent services to a network of patent attorneys such as to the LLPs 1402A-N and solo practices 1404A-N associated with the organization 1400. The organization 1400 may include a core training group to train patent engineers as per a uniform best practice methodology per technology area (e.g., devised by the advisory board). The organization 1400 may also facilitate quality control process that may ensure quality control of work product. The organization 1400 may include patent attorneys, patent engineers, paralegal staff, patent illustrators, etc. interacting with the LLPs 1402A-N and/or the solo practices 1404 A-N. In addition, the organization 1400 may manage an accounting function, a finance function, an operation function, a recruiting function, an administrative function and/or a workflow function. The organization 1400 may also preserve client confidences between the LLPs 1402 A-N and their clients and/or prevent conflict of interest that may arise while screening of the patent application (e.g., by the QC group 1504). The LLPs 1402 A-N and the solo practices 1404 A-N are interacting with professionals of the organization 1400 (e.g., forming the network with the organization 1400) according to the example embodiment illustrated in FIG. 14.

FIG. 15 is a system view of the quality control process of the organization 1400, according to one embodiment. Particularly, FIG. 15 illustrates the organization 1400 (e.g., LegalForce, Inc.), the LLPs 1402 A-N (e.g., the LLPs 1402 A-N and/or the solo practices 1404 A-N of FIG. 14), attorney contacts 1502 A-N, a QC (e.g., Quality Control) group 1504, a core training group 1506, units A,B,C, and D (e.g., the units may represent patent engineers being trained by the core training group 1506), and trained units A1, B1, C1, and D1 (e.g., the trained units may represent the patent engineers A,B,C, and/or D at a fully trained stage), according to one embodiment.

The attorney contacts 1502 A-N (e.g., patent attorneys) may be associated with the LLPs 1402 A-N (e.g., a patent attorney may interact with a particular LLP 1402 A-N and/or solo practices 1404 A-N of FIG. 14). For example, the attorney contacts 1502 A-N having an exposure to particular technology area (e.g., electrical, thermal, bio-tech, mechanical, etc.) may be associated with the particular LLPs 1402 A-N and/or the solo practices 1404 A-N having practice focus in same technology area as the attorney contacts 1502 A-N.

The QC group 1504 may contain non-attorneys and may interact with the attorney contacts 1502 A-N to watch over (e.g., direct, correct, enforce, etc.) an ongoing quality control process (e.g., may include formatting, grammatical accuracy, paragraph number check, and/or antecedent basis check, etc.). The QC group 1504 may also preserve client confidences between various LLPs 1402 A-N and their clients. The QC group 1504 may prevent conflict of interest that may arise during screening of patent applications managed by the QC group 1504 of the foreign jurisdiction entity 402.

The QC group 1504 may include the non-attorney (e.g., not carrying out a practice of law) which may perform procedural checks on the work product to train the A, B, C and/or D and to maintain high quality standard work product. The core training group 1506 may include the professionals (e.g., attorneys, patent agent, educators, etc.) to train and prepare a team based on the uniform best practice per technology area methodology developed by the advisory board (e.g., the advisory board 112 of FIG. 1).

The fully trained client-facing professionals A, B, C, and D may directly interact with the attorney contacts 1502 A-N and/or the LLPs 1402 A-N through the separate entity 708 of the professional service network in the foreign jurisdiction.

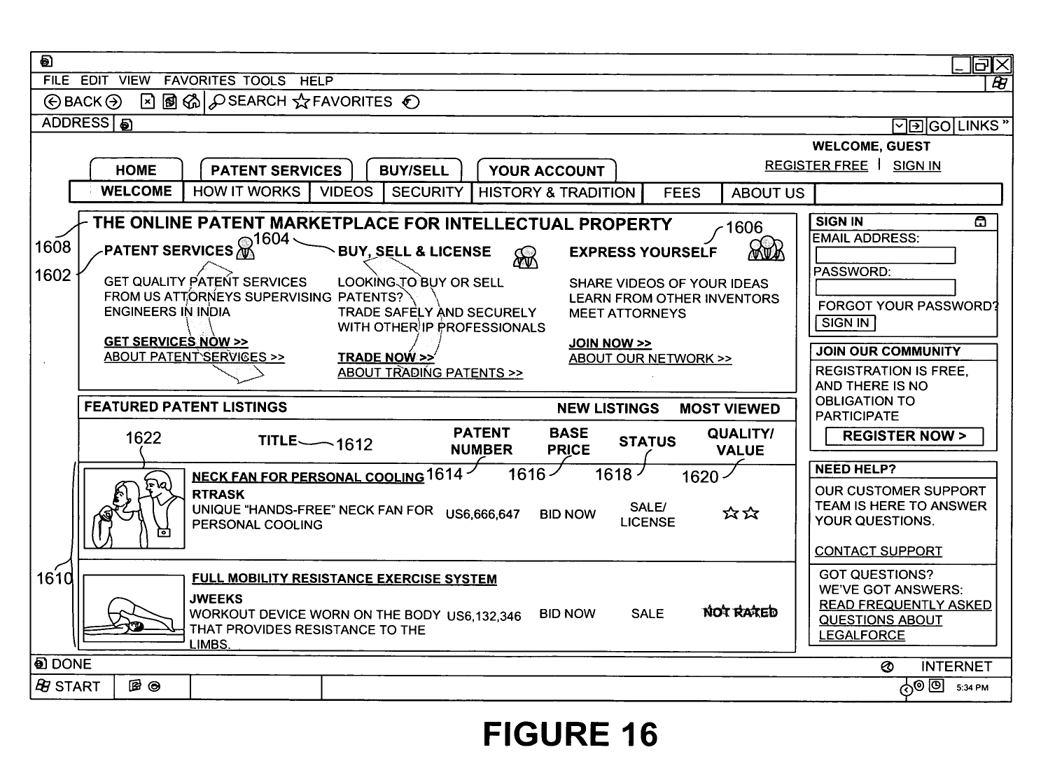

FIG. 16 is a user interface view of an online marketplace for intellectual property, according to one embodiment. Particularly, FIG. 16 illustrates a patent services link 1602, a buy, sell and license link 1604, an express yourself link 1606, a caption view 1608, a patent listing view 1610, a title field 1612, a patent number field 1614, a base price field 1616, a status field 1618, a quality/value field 1620 and a graphics view 1622, according to one embodiment.

The patent services link 1602 may offer information about quality patent services rendered to a user by U.S. patent attorneys supervising engineers in India through links “get services now” and “about patent services”. The buy, sell and license link 1604 may reference information about buying, selling and/or licensing of patents online through further links “trade now” and “about trading patent”.

The express yourself link 1606 may enable the user to share of video(s) related to ideas of the inventors, arrange meeting U.S. attorneys and learn from other inventors through links “join now” and “about our network”. The caption view 1608 may display a caption which may attract the user to view a marketing message that may be included in a webpage. The listing view 1610 may display detailed features of listed patented inventions available for sale and/or license.

The title field 1612 may display title of invention, assignee, and/or a marketing message related to an invention. The patent number field 1614 may display a patent number assigned to the patented inventions by patent and trademark office (e.g., USPTO, EPO, PCT, etc.). The base price field 1616 may facilitate the user (e.g., the user targeting to trade patents online) to bid for the patents online. The status field 1618 may display status of the listed patents (e.g., whether the patents listed are available for sale and/or license). The quality/value field 1620 may display ratings of the listed patents which may enable ranking quality of the patents available for trade as per a predetermined method. The graphics view 1622 may display an image associated with the method, apparatus, system and/or utility of the patents listed in the listing view 1610.

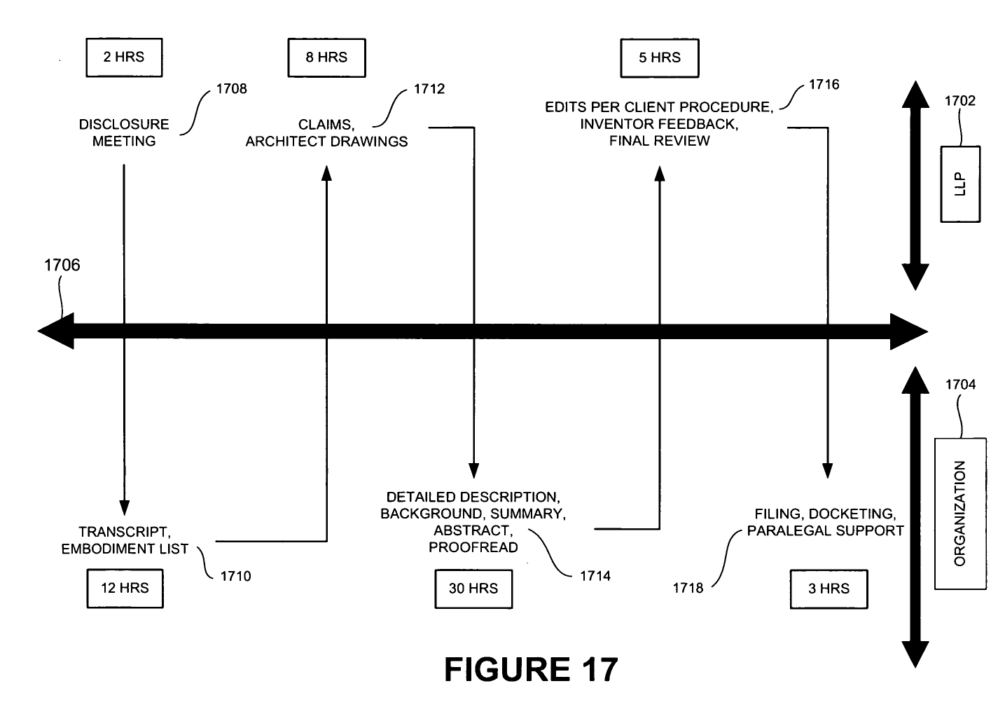

FIG. 17 is a process flow view of various steps of patent application drafting, according to one embodiment. Particularly, FIG. 17 illustrates a LLP 1702, an organization 1704, a timeline axis 1706, a disclosure meeting field 1708, a transcript embodiment list field 1710, a claims, architect drawings field 1712, a detailed description, background, summary, abstract, proofread field 1714, an edits per client procedure, inventor feedback, a final review field 1716 and filling, docketing, a paralegal support field 1718, according to one embodiment.

The LLP 1702 (e.g., limited liability partnerships, law firms, patent law firms, etc.) may be an entity (e.g., a firm, an organization, a company, an enterprise, etc.) associated with the enabling module 100. The LLPs 1702 may manage disclosure meetings, claims, architect drawings and edits per client procedure, inventor feedback final review, etc.

The organization 1704 may be a corporate entity of the client-facing professionals 706 of the professional service network in the foreign jurisdiction associated with the central module 106 which manages transcription, preparation of embodiment list, writing detailed description, background, summary, abstract, proofread, filling, and docketing paralegal support, etc. The timeline axis 1706 may be a chronological distribution of a workflow (e.g., associated with patent drafting and filing process) between the LLP 1702 and the organization 1704. The disclosure meeting field 1708 may be a discussion between a client (e.g., an inventor, an organization, an investor, a research person, etc.) and the client-facing professional(s) 706 of the professional service network in which an idea and/or details of an invention may be disclosed and may prolong for 2 hours.

The transcript, embodiment list field 1710 may be a copy, a record and/or text preparation related to the ideas of the invention disclosed during the disclosure meeting 1708 between the clients 108A-B and 110 and the client-facing professionals 706 of the foreign jurisdiction which may require at least 12 hours. The claim, architect drawings field 1712 may be a next process (after preparation of the transcription and/or the embodiment list) carried out by the client-facing professionals 706 and/or may include drafting of claims, figures, etc. and may consume 8 hours of the attorneys time.

The detailed description, background, summary, abstract, proofread field 1714 may be a task performed by professionals (e.g., the patent engineers) of the organization 1704 and may consume 30 hours of their valuable time. The detailed description may be quality description (e.g., corresponding to the figures and claims) related to the invention disclosed by the client (e.g., the clients 108A-B and the client 110 of FIG. 1). The summary may be a shortened version of the description related to the invention including the importance of invention in a short period of time.

The abstract may be a brief statement of important aspects of the invention and/or may include creative and/or complex ideas of invention. The process of proofreading may involve reading a proof copy of a text in order to detect and correct any errors and may be carried out by the QC group 1504 of the professional service network. Edits per client procedure, inventor feedback, and final review field 1716 may include any change and/or feedbacks from the clients to the service provided by the client-facing professional 706 and patent attorneys of the professional service network followed by the final review by the attorneys of the LLP 1702 and may consume at least 5 hours. The filing, docketing, paralegal support field 1718 may be a final step of the patent application drafting and filing and may include filling, docketing of the relevant application and/or paralegal support by expertise paralegal professionals of the professional network services.

For example, John Doe may be a patent attorney focusing on patent preparation and prosecution services at BigLaw LLP, a patent law firm based in Palo Alto, Calif. John may be a senior associate attorney at BigLaw LLP, and may make partner (e.g., be promoted to partner status at BigLaw LLP) in a few years. John may be a hardworking, personable patent attorney who prepares and writes high quality patents. John may have developed a good book of business (e.g., client base) of his own clients worth $300,000 and enjoys the respect of his peers at the firm and within the field of patent law.

However, John may not be entitled to a share of his own billings at BigLaw LLP and may instead receive a fixed salary of $150,000 per year. However, $200,000 of the billings generated by John may go to partner profits of which John does not have any share. The remaining $250,000 generated by John's book of business per year may include overhead costs and expenses borne by BigLaw LLP (e.g., associated with the cost of services rendered by John). Furthermore, John may be forced to work on client work fed to him by partners at BigLaw LLP because he does not have time to spend on developing his own client base and client relationships. John may also be restricted by senior partners of BigLaw LLP from courting large clients (e.g., multinational companies).

John may further have to ensure that he records a minimum of 2000 billable hours (e.g., 2000 hours spent doing patent work, of which all must be billable to clients) per year for BigLaw LLP, or he may be at risk for not being eligible to make partner. BigLaw LLP may require associates at the firm to consistently meet a 2000 hour per year minimum billable hours requirement for 5-7 consecutive years before becoming eligible to make non-equity partner. John may have to work 50-60 hours a week to enable him to achieve his minimum billable hours requirement.

Furthermore, John may be tired of constantly performing rote tasks in which his legal talent is not fully utilized, even though they are necessary aspects of the work he does. For example, John may realize that architecting claims and figures for patent applications are the most important aspects of patent preparation. However, aspects such as writing detailed descriptions, summaries, abstracts, backgrounds and/or formalizing architected figures are also necessary components of patent preparation, although they may not require his level of skill to perform.

John may also not be able to spend enough time on the core portions of the patent applications he writes for his clients. In order to do a good job on these portions, he would have to spend considerable amounts of time, and since John bills his clients according to an hourly rate (e.g., that may regularly increase under the pressure of higher billing rates set by partners at BigLaw LLP and other patent law firms who may be seeking to make more profits), John may be unable to spend as much time as he might like or that might be necessary in order to produce high quality work on the core portions of the patent application for a client with a fixed budget.

For example, John may bill his clients at $300 per hour. John's average client may have a budget of $10,000 per patent application. John may spend 16 hours on the core portion of each patent application (e.g., architecting the claims and the figures and doing a final review of an application), which would add up to $4,800. The non-core portion of a patent application (e.g., preparing formal drawings, detailed descriptions, a background, a summary, an abstract, etc.) may require 22 hours in order for John to do a good job, which would add up to an additional $6,600.

In order to write a high quality patent application for the client, John would have to spend 38 hours, or $11,400 worth of his billable time. John would either have to write off $1,400 of his work, or spend almost 5 hours less on the patent application. John may not be able to spend enough time on the core portion of the patent application to ensure that he produces work of a highest quality possible. Furthermore, in order to accommodate a client's budget, and/or because John may dislike spending too much time on repetitive aspects of the non-core portion of the patent application, John may take shortcuts such as dictating the detailed descriptions and having them transcribed for him, not making carefully sure that every claim is supported in the specifications of the application, not architecting drawings that may best tell a story of an invention to a potential jury during litigation, not preparing drawings according to requirements of the United States Patent and Trademark Office, not proofreading the detailed descriptions to ensure that all the figures are supported, etc. The shortcuts or omissions John may make may detract from an overall quality and strength of the patent application, if issued.

John's working conditions may be stressful, and his quality of life may suffer because he does not have enough time away from his work to spend with his friends and family, or to pursue his hobbies and interests. For example, John may be constantly stressed about making his minimum billable hours requirement, and/or may dread taking time off because of the billable hours he would have to make up. John may dislike playing politics (e.g., attempting to curry favor with partners at the firm or trying to please people he dislikes) in an attempt to move up and become Partner. Unfortunately for John, playing politics may be a necessary and/or helpful strategy for associates at BigLaw LLP hoping to make non-equity partner.

However, even after making partner, there may be no guarantee that John would receive the benefits and he might imagine he would. The hierarchical management pyramid at BigLaw LLP (e.g., the hierarchical partner track John is on) may extend beyond a transition from an associate status to a partner status at the firm. For example, a partner of BigLaw LLP who is a non-equity partner may receive fewer benefits than an equity partner at the firm, while various partners may control the billings and workflow of other partners who may be lower in the hierarchy. Reaching an apex of the partner pyramid may take decades, and John may get frustrated that he does all the work for his clients, and the partners at BigLaw LLP make all the profits without John being able to keep a share of his own billings.

John may face a highly uncertain career path and may be frustrated that has little control over his support staff, and/or John may wish he could leave the stressful conditions of his position at BigLaw LLP and start his own practice where he can keep all of his own billings, be more independent and not answerable to higher ranking partners and/or have more control over the nature and the intensity of his workload. John may be a good patent attorney, but he may be disinclined to establish his own practice because he may think he would not be able to handle the logistical and administrative hassles involved (e.g., transferring his files, informing all his clients and hoping that they follow him to his new practice, registering his new practice, setting up an office and/or the support services he may require, managing billing, accounting and administrative tasks, hiring or arranging for a patent paralegal for his practice and/or docketing his files, etc.).

John may also have become comfortable with and/or take for granted the perks of his position at BigLaw LLP, where he may enjoy paralegal support, firm parties and/or benefit packages, administrative assistants and docketing clerks, on-site CLE classes (e.g., for John's continuing legal education in the field of intellectual property), etc., and may not wish to have to forego these comforts by starting his own practice by himself.

However, John may come to learn about a certain network of patent attorneys (e.g., called LegalForce, Inc.) from his friends, colleagues, events and/or recruiters associated with LegalForce, Inc. LegalForce, Inc. may offer patent attorneys a complete startup and support solution to start their own practices by leaving their current firms and joining a LegalForce network of select patent attorneys, screened for their talent and skill in the field of patent preparation and prosecution. LegalForce, Inc. may include an advisory board of luminaries in the field of patent law who regularly establish and revise a set of best practices per technology area (e.g., a methodology) to guide the members of the LegalForce network of patent attorneys.

LegalForce, Inc. may allow patent attorneys to start their own practices (e.g., solo practices, partnerships, firms, etc.) and maintain their own trade identities (e.g., the patent attorney may call his/her newly formed entity by any name, may generate client relationships, and/or may market the entity's services independently of a network. LegalForce, Inc. may provide patent attorneys of the network with the complete startup solution (e.g., including office space, website creation and services, utilities, communication services, billing, accounting and administrative support, etc.) as well as full patent services support (e.g., including fully trained paralegal support, patent engineers and/or agents, docketing clerks, patent illustrators, etc.) through globally leveraged support teams (e.g., in India).

The patent attorneys having practices that they started through the LegalForce network may be dedicated trained patent services support teams in India by LegalForce, Inc. to perform non-core portions of patent preparation work (e.g., formalizing figures architected by the patent attorneys, preparing detailed descriptions based on the claims and figures for each application architected by the patent attorneys, formalizing drawings, docketing matters and/or filing and prosecuting applications with patent offices, etc.), allowing the patent attorneys to dedicate more time on the core portions of the work.

The LegalForce network may select India as a location for the trained patent services support teams of the patent attorneys based on various factors (e.g., the wage and/or labor in India may be lower than in the U.S., India may have infrastructure that can support LegalForce operations, there may be an availability of skilled and/or trainable labor in India, India may be economically and/or politically stable, etc.). The fact that fully trained foreign support teams of the LegalForce network may be able to perform the non-core portion of John's patent work may be appealing to John, because it may mean that he could improve the quality of the core portions of patent applications by allowing more time to be spent on them, could have more time dedicated to the non-core portions of patent applications within a given client budget, and/or could be able to free up more of his time to focus on the core portion of the applications, to source and develop new client relationships, and/or to have more free time.

The LegalForce network may provide John with all the patent related and non-patent related services he needs for starting his own practice and producing high quality patent applications for his clients. LegalForce, Inc. may further allow John to keep 50% of his own billings, the other 50% being processed by the network as a management fee for the services provided to John. For example, if John joins the LegalForce network, he may be able to port his existing clients into a central account management facility of the LegalForce network, so that he may not have to worry about managing his client files, docketing matters and/or billing clients, etc.

LegalForce, Inc. may provide John fully trained patent services (e.g., located in India) and support services team to perform the non-core portion of John's patent work for his clients. The LegalForce network may preserve confidentiality of information communicated between John and his clients under an attorney client privilege, and/or may extend client confidentiality to encompass John's support teams based in India under an attorney work product privilege. The LegalForce network may provide an assistant to John and other patent attorneys having practices associated with the network to perform various functions (e.g., invoicing clients, processing payments of clients, etc.).

John may refer work to and/or receive referrals from other patent attorneys of the LegalForce network based on whether John and/or the other patent attorneys have a capacity to take on additional work and/or clients. LegalForce, Inc. may manage possible conflicts of interest between John's clients, and/or may create ethical separations between tasks performed by John and/or his support team in India and those performed by other patent attorneys (e.g., and their support teams) associated with the LegalForce network. LegalForce Inc. may be a corporate entity that can raise capital and/or equity from parties outside the LegalForce network (e.g., investors) without violating regulations of State Bar Associations with which the patent attorneys of the LegalForce network may be licensed and/or registered (e.g., by not being organized as a law firm, by not performing law practice of writing claims and architecting figures, and/or by not signing off on patent applications). LegalForce, Inc. may internally classify the portions of a work done by John and/or his support team as being subject to an export control regulation, and may maintain documentation of the work portions in compliance with the automatic licensure procedure of the export control regulation prior to engaging the support team in India with any portion of the work. LegalForce, Inc. may further provide engagement letters to John's clients to ensure that a client has previously exported any technology that may be subject to the export control regulation.

LegalForce, Inc. may also provide John with stock options in LegalForce, Inc. based on the value of the book of business he brings into the network, the quality of John's patent work in alignment with the best practices methodology set by the LegalForce advisory board, an amount of time John has been a part of the LegalForce, Inc., and/or feedback ratings from John's clients.

John may recognize that LegalForce, Inc. would offer him all the startup service and support solutions he may require to start his own practice without his having to worry about any of the administrative hassles involved, would provide him with the fully trained patent support services team based in India, which would allow him to focus his time on improving the quality of the core portions of patent application preparation and prosecution while also increasing the quality of the non-core portions of the patent applications handled by the support team in India (e.g., by allowing additional time in a given budget to be allocated to the non-core portion of the patent application preparation), would allow him to keep 50% of his own billings (e.g., as compared to approximately 30% that he may receive at BigLaw LLP), and would facilitate a growth of his client base by other patent attorneys in the network referring him work, in addition to handling all his account management and administrative needs associated with his new practice.

Although the previous example describes a hypothetical senior associate at the patent law firm (e.g., John Doe of BigLaw LLP), John Doe as representing a party may be interested in joining LegalForce, Inc. may also be an attorney having a solo patent practice, and/or may be a lifestyle patent law firm (e.g., a firm smaller than BigLaw LLP having 9-10 attorneys, a flatter management structure and more flexible work hours).

A solo patent practitioner may not have the resources to find and/or support a good (e.g., well-trained) team of patent paralegals, patent engineers, docketing clerks and/or patent illustrators. Furthermore, the solo practitioner may have to personally manage administrative hassles, overheads and maintenance costs for his/her practice, and accounting/billing functions.

The solo practitioner may not have as large a client base as he/she could, because of various inefficiencies that may restrict the solo practitioner from growing his/her client base (e.g., in quantity as well as quality of clients) as much as he/she may like and/or may have the capacity of managing. The solo practitioner may join LegalForce, Inc. because he/she is assured of being provided a highly-trained support team, a complete solution for managing administrative, billing and support functions, and more time to focus on producing high quality patent application and/or growing his/her client base.

Similarly, a smaller patent law firm (e.g., a lifestyle law firm with easier working conditions and the flatter management structure for its 9-10 attorneys than a large patent law firm like BigLaw LLP) may find it difficult to source and retain highly trained patent support teams for its attorneys. Attorneys at the smaller firm may have to personally prepare non-core portions of patent applications such as detailed descriptions, formalizing drawings, abstracts, summaries, etc., and may find it difficult to dedicate enough time on work on core portions of the work for a given client budget in order to ensure that they produce the high quality patent application.

The smaller firm may also have to handle management, administrative and billing hassles associated with the running of the firm. The smaller patent law firm may join LegalForce, Inc. because it would not have to deal with an administrative or billing functions associated with the running of the firm, the attorneys of the firm would be provided highly trained patent support teams, and the firm would be able to ensure high quality standards for the patent work it handles because its attorneys would have more time to focus on core portions of patent applications.

Although the present embodiments have been described with reference to specific example embodiments, it will be evident that various modifications and changes may be made to these embodiments without departing from the broader spirit and scope of the various embodiments. For example, the various devices, modules, analyzers, generators, etc. described herein may be enabled and operated using hardware circuitry (e.g., CMOS based logic circuitry), firmware, software and/or any combination of hardware, firmware, and/or software (e.g., embodied in a machine readable medium). For example, the various electrical structure and methods may be embodied using transistors, logic gates, and electrical circuits (e.g., Application Specific Integrated Circuitry (ASIC) and/or in Digital Signal Processor (DSP) circuitry).

For example, the enabling module 100, the central module 106, the advisory module 112, the account module 200, the operations module 202, the professional module 204, the financial module 206, the client module 208, the control module 210, the porting module 212, the billing module 216, the tracking module 218, the selection module 222, the marketing module 224, the accounting module 226, the legal module 228, the QC module 230, the startup module 232, the contract module 234, the service module 236, the capacity balancing module 238, the management fee module 242, the incentive module 244, the sales module 246, the management module 248, the labor module 300, the training module 302, the engineer module 304, the illustrator module 306, the paralegal module 308, the recruiting module 310, the support module 312, the IT module 314, the HR module 316, the administrative module 318, the segmentation module 320, and other modules may be enabled using an enabling circuit, a central circuit, an advisory board circuit, an account circuit, an operations circuit, a professional circuit, a financial circuit, a client circuit, a control circuit, a porting circuit, a billing circuit, a tracking circuit, a selection circuit, a marketing circuit, an accounting circuit, a legal circuit, a QC circuit, a startup circuit, a contract circuit, a service circuit, a capacity balancing circuit, a management fee circuit, an incentive circuit, a sales circuit, a management circuit, a labor circuit, a training circuit, an engineer circuit, an illustrator circuit, a paralegal circuit, a recruiting circuit, a support circuit, an IT circuit, an HR circuit, an administrative circuit, a sementation circuit and other circuits using one or more of the technologies described herein.

In addition, it will be appreciated that the various operations, processes, and methods disclosed herein may be embodied in a machine-readable medium and/or a machine accessible medium compatible with a data processing system (e.g., a computer system), and may be performed in any order. Accordingly, the specification and drawings are to be regarded in an illustrative rather than a restrictive sense.

What is claimed is:

1. A method of a network of patent attorneys, comprising:
providing a holistic patent services support solution to a patent attorney forming a separate entity;
permitting the separate entity to adopt a trade identity different than that of the network of patent attorneys; and
performing a core portion of a patent legal service through the separate entity of the patent attorney.

2. The method of claim 1, wherein the providing the holistic patent services support solution comprises:
segmenting a task portion of a professional service from the core portion of the patent legal service based on a skill level required to perform the task portion and the core portion; and
improving a quality benchmark of the task portion of the patent legal service by performing the task portion in a foreign jurisdiction entity where a foreign labor rate permits the task portion to be dedicated additional time in a given budget.

3. The method of claim 2, further comprising:
transferring a relationship between the patent attorney and a client to the network of the patent attorneys; and
marketing a corporate ownership interest of the network of patent attorneys to parties other than members of a State Bar Association to which the patent attorney belongs without violating a regulation of the State Bar Association when the core portion is performed through the separate entity, wherein a separate entity ownership interest is owned entirely by the members of the State Bar Association.

4. The method of claim 3, further comprising providing the corporate ownership interest as stock options to the patent attorney based on at least one of an origination revenue, an objective quality-benchmark of work product, a tenure, and a client feedback rating of the patent attorney.

5. The method of claim 2, further comprising selecting a foreign jurisdiction based on a writing skill profile, an education profile, an infrastructural profile, a judicial precedent profile, a political profile, a labor cost profile, a language proficiency profile, an economic profile, a cultural profile, and a special expertise profile.

6. The method of claim 2, further comprising:
training employees of the foreign jurisdiction entity through a uniform best practice per technology area methodology developed by an advisory board of recognized experts in a field of patent law;
providing an internal quality control team of the network of patent attorneys to monitor and manage adherence to the uniform best practice per technology area methodology; and
periodically revising the uniform best practice per technology area methodology based on at least one of a judicial action, a legislative action, a discontinuity and a regulatory action affecting the best practice methodology.

7. The method of claim 6, wherein the employees of the foreign jurisdiction entity who display exceptional skill in performing the task portion of the patent legal service are provided an incentive to become a patent professional in a primary jurisdiction through at least one of an educational opportunity reimbursement in the primary jurisdiction and a work status sponsorship in the primary jurisdiction.

8. The method of claim 6, wherein the patent attorney is selected after an objective evaluation of a skill of the patent attorney in alignment with the uniform best practice per technology area methodology developed by the advisory board.

9. The method of claim 8, further comprising creating a linkage between the patent attorney and certain other patent attorneys in the network of patent attorneys through a common fraternal marker, such that the patent attorney and the other patent attorneys in the network of patent attorneys are recognizable as being preeminent practitioners of the patent law.

10. The method of claim 6, further comprising qualifying the foreign jurisdiction entity as a franchised entity of the network of patent attorneys based on a conformance with a particular portion of the uniform best practice per technology area methodology.

11. The method of claim 2, further comprising maintaining a governmental privilege between the patent attorney and a client through the separate entity by performing the core portion of the patent legal service in the separate entity.

12. The method of claim 11, wherein the governmental privilege is extended to employees of the foreign jurisdiction entity when performing the task portion under a supervision of the patent attorney, and wherein the governmental privilege is at least one of an attorney client privilege and an attorney work product privilege.

13. The method of claim 12, wherein a confidentiality is maintained by the network of patent attorneys to preserve client confidences through a set of purge and segmentation policies that ensure that a confidential information does not escape a privileged workgroup formed between the patent attorneys and the foreign jurisdiction entity.

14. The method of claim 2, further comprising:
internally classifying at least one of the core portion and the task portion as being subject to an export control regulation; and
maintaining documentation of the core portion and the task portion in compliance with an automatic licensure procedure of the export control regulation prior to engaging the foreign jurisdiction entity with the task portion.

15. The method of claim 14, further comprising providing an engagement letter to a client to ensure that the client has previously exported any technology that is subject to the export control regulation.

16. The method of claim 1, wherein the patent attorney is recruited from an external network when the patent attorney has an independent client base above a threshold value.

17. The method of claim 1, further comprising providing an assistant of the network of patent attorneys to the patent attorney to manage at least one of a workflow distribution, a finance function, an accounting function, an administrative function, and a marketing function.

18. The method of claim 17, further comprising:
generating an invoice of the separate entity using the finance function managed by the assistant of the network of patent attorneys;
processing a payment of a client to the separate entity through the network of patent attorneys when the assistant performs the finance function; and
allocating a portion of the payment as a management consideration to the network of patent attorneys when the payment to the separate entity is processed.

19. The method of claim 1, further comprising:
providing the separate entity of the patent attorney with the core portion of the patent legal service generated through a relationship directly between the network of patent attorneys and a different client; and
compensating the patent attorney based on a satisfactory completion of the core portion of the patent legal service.

20. The method of claim 19, further comprising balancing a service capacity in the network of patent attorneys by the patent attorney providing a referral to other patent attorneys of the network of patent attorneys when the patent attorney has an unavailable status, a conflict status, a vacation status, and an overloaded status.

21. The method of claim 1, further comprising permitting the patent attorney to accept legal service engagements apart from the network of patent attorneys when the legal service engagements are not in a patent related focus area of the network of patent attorneys.

22. The method of claim 1, further comprising:
managing a conflict of interest between a client and other clients of the patent attorney in the separate entity; and
creating an ethical separation between tasks of the separate entity from other separate entities associated with the network of patent attorneys to address the conflict of interest.

23. The method of claim 22, wherein the ethical separation is at least one of a physical separation, a patent support staff separation, a geographic separation, a task force separation, an electronic separation, a database separation, a communication separation, and a workflow separation.

24. The method of claim 1, further comprising providing endemic services in the holistic patent services support solution including a patent paralegal support, an engineer allocation, a patent engineer allocation in a foreign jurisdiction, a patent agent allocation in the foreign jurisdiction, a search specialist allocation, a docketing clerk allocation in the foreign jurisdiction, and a patent illustrator allocation in the foreign jurisdiction.

25. The method of claim 24, further comprising providing patent support services in the holistic patent services support solution including an organization formation service, a real estate service, an office management service, a training service, a marketing collaboration service, a recruiting service, a marketing cooperative service, an advertising cooperative service, a professional website creation service, a billing service, an accounting service, a matter management service, a consulting service, and a collections service.

26. The method of claim 1, in a form of a machine-readable medium embodying a set of instructions that, when executed by a machine, causes the machine to perform the method of claim 1.

27. A method of a professional service network, comprising:
providing a holistic professional support solution to a client-facing professional forming a separate entity;
permitting the separate entity to adopt a trade identity different than that of the professional service network; and
performing a core portion of a professional service through the separate entity of the client-facing professional.

28. The method of claim 27, wherein the providing the holistic professional support solution comprises:
segmenting a task portion of the professional service from the core portion of the professional service based on a skill level required to perform the task portion and the core portion; and
improving a quality benchmark of the task portion of the professional service by performing the task portion in a foreign jurisdiction entity where a foreign labor rate permits the task portion to be dedicated additional time in a given budget.

29. The method of claim 28, further comprising:
transferring a relationship between the client-facing professional and a client to the professional service network; and
marketing a corporate ownership interest of the professional service network to parties other than members of a trade organization to which the client-facing professional belongs without violating a regulation of the trade organization when the core portion is performed through the separate entity, wherein a separate entity ownership interest is owned entirely by the members of the trade organization.

30. The method of claim 29, further comprising providing the corporate ownership interest as stock options to the client-facing professional based on at least one of an origination revenue, an objective quality-benchmark of work product, a tenure, and a client feedback rating of the client-facing professional.

31. The method of claim 28, further comprising selecting a foreign jurisdiction based on a writing skill profile, an education profile, an infrastructural profile, a judicial precedent profile, a political profile, a labor cost profile, a language proficiency profile, an economic profile, a cultural profile, and a special expertise profile.

32. The method of claim 28, further comprising:
training employees of the foreign jurisdiction entity through a uniform best practice per technology area methodology developed by an advisory board of industry recognized experts;
providing an internal quality control team of the professional service network to monitor and manage adherence to the uniform best practice per technology area methodology; and
periodically revising the uniform best practice per technology area methodology based on at least one of a judicial action, a legislative action, a discontinuity and a regulatory action affecting the best practice methodology.

33. The method of claim 32, wherein the employees of the foreign jurisdiction entity who display exceptional skill in performing the task portion of the professional service are provided an incentive to become a client-facing professional in a primary jurisdiction through at least one of an educational opportunity reimbursement in the primary jurisdiction and a work status sponsorship in the primary jurisdiction.

34. The method of claim 32, wherein the client-facing professional is selected after an objective evaluation of a skill of the client-facing professional in alignment with the uniform best practice per technology area methodology developed by the advisory board.

35. The method of claim 34, further comprising creating a linkage between the client-facing professional and certain other client-facing professionals in the professional service network through a common fraternal marker, such that the client-facing professional and the other client-facing professionals in the professional service network are recognizable as being preeminent practitioners in their professions.

36. The method of claim 32, further comprising qualifying the foreign jurisdiction entity as a franchised entity of the professional service network based on a conformance with a particular portion of the uniform best practice per technology area methodology.

37. The method of claim 28, further comprising maintaining a governmental privilege between the client-facing professional and a client through the separate entity by performing the core portion of the professional service in the separate entity.

38. The method of claim 37, wherein the governmental privilege is extended to employees of the foreign jurisdiction entity when performing the task portion under a supervision of the client-facing professional, and wherein the governmental privilege is at least one of an attorney client privilege and an attorney work product privilege.

39. The method of claim 38, wherein a confidentiality is maintained by the professional service network to preserve client confidences through a set of purge and segmentation policies that ensure that a confidential information does not escape a privileged workgroup formed between the client-facing professional and the foreign jurisdiction entity.

40. The method of claim 28, further comprising:
internally classifying at least one of the core portion and the task portion as being subject to an export control regulation; and
maintaining documentation of the core portion and the task portion in compliance with an automatic licensure procedure of the export control regulation prior to engaging the foreign jurisdiction entity with the task portion.

41. The method of claim 40, further comprising providing an engagement letter to a client to ensure that the client has previously exported any technology that is subject to the export control regulation.

42. The method of claim 27, wherein the client-facing professional is recruited from an external network when the client-facing professional has an independent client base above a threshold value.

43. The method of claim 27, further comprising providing an assistant of the professional service network to the client-facing professional to manage at least one of a workflow distribution, a finance function, an accounting function, an administrative function, and a marketing function.

44. The method of claim 43, further comprising:
generating an invoice of the separate entity using the finance function managed by the assistant of the professional service network;
processing a payment of a client to the separate entity through the professional service network when the assistant performs the finance function; and
allocating a portion of the payment as a management consideration to the professional service network when the payment to the separate entity is processed.

45. The method of claim 27, further comprising:
providing the separate entity of the client-facing professional with the core portion of a professional service generated through a relationship directly between the professional service network and a different client; and
compensating the client-facing professional based on a satisfactory completion of the core portion of the professional service.

46. The method of claim 45, further comprising balancing a service capacity in the professional service network by the client-facing professional providing a referral to other client-facing professionals of the professional service network when the client-facing professional has an unavailable status, a conflict status, a vacation status, and an overloaded status.

47. The method of claim 27, further comprising permitting the client-facing professional to accept professional service engagements apart from the professional service network when the professional service engagements are not in a category focus area of the professional service network.

48. The method of claim 27, further comprising:
managing a conflict of interest between a client and other clients of the client-facing professional in the separate entity; and
creating an ethical separation between tasks of the separate entity from other separate entities associated with the professional service network to address the conflict of interest.

49. The method of claim 48, wherein the ethical separation is at least one of a physical separation, a support staff separation, a geographic separation, a task force separation, an electronic separation, a database separation, a communication separation, and a workflow separation.

50. The method of claim 27, further comprising providing endemic services in the holistic professional support solution including a paralegal support, an apprentice allocation in a foreign jurisdiction, an illustrator allocation in the foreign jurisdiction, and an engineer allocation in a foreign jurisdiction.

51. The method of claim 50, further comprising providing support services in the holistic professional support solution including an organization formation service, a real estate service, an office management service, a training service, a marketing collaboration service, a recruiting service, a marketing cooperative service, an advertising cooperative service, a professional website creation service, a billing service, an accounting service, a matter management service, a consulting service, and a collections service.

52. The method of claim 27 in a form of a machine-readable medium embodying a set of instructions that, when executed by a machine, causes the machine to perform the method of claim 27.

53. A method of a separate entity, comprising:
performing a task portion of a professional service through a foreign jurisdiction entity where a foreign labor rate permits the task portion to be dedicated additional time in a given budget; and
preserving a client confidence through a set of policies that ensure that a confidential information does not escape a privileged workgroup formed between a client-facing professional of the separate entity and a partitioned team of the foreign jurisdiction entity.

54. The method of claim 53, further comprising providing a management fee to the foreign jurisdiction entity when a payment of the professional service is collected by the foreign jurisdiction entity on behalf of the separate entity.

55. The method of claim 54, further comprising accepting a corporate ownership interest incentive in at least one of the foreign jurisdiction entity and an enabling entity of the foreign jurisdiction entity based on at least one of an origination revenue, an objective quality-benchmark of work product, a tenure, and a client feedback rating of the client-facing professional of the separate entity.

56. The method of claim 53, further comprising:
internally classifying at least one of a core portion and the task portion as being subject to an export control regulation; and
maintaining documentation of the core portion and the task portion in compliance with an automatic licensure procedure of the export control regulation prior to engaging the foreign jurisdiction entity with the task portion.

57. The method of claim 56, further comprising:
screening in the separate entity a conflict of interest risk between clients of the separate entity; and
creating a physical and electronic barrier of work product accessibility of the separate entity by other separate entities and support teams of the foreign jurisdiction entity.

58. The method of claim 57, wherein the separate entity, the other separate entities, and the foreign jurisdiction entity are members of a globalized professional service network which provides best practices training of the professional service to its members, which provides a comprehensive practice startup and support solution to the separate entity and the other separate entities through the foreign jurisdiction entity, and in which members of a professional service network provide referrals to other members of a professional service network.

59. The method of claim 53, in a form of a machine-readable medium embodying a set of instructions that, when executed by a machine, causes the machine to perform the method of claim 53.

60. A system, comprising:
a network of separate entities formed and managed by an enabling organization;
a central organization of the enabling organization to provide support services to the network of separate entities; and
a group of clients having at least a portion of a service performed using the central organization through an oversight by at least some experienced professionals of the separate entities.

61. The system of claim 60, wherein the central organization is located in a jurisdiction selected based on at least one of a writing skill profile, an education profile, an infrastructural profile, a judicial precedent profile, a political profile, a labor cost profile, a language proficiency profile, an economic profile, a cultural profile, and a special expertise profile of the jurisdiction.

62. The system of claim 60, wherein the enabling organization performs a set of services for each separate entity of the network of separate entities including an organization formation service, a real estate service, an office management service, a training service, a recruiting service, a marketing collaboration service, a marketing cooperative service, an advertising cooperative service, a professional website creation service, a billing service, an accounting service, a matter management service, a consulting service, and a collections service.

63. The system of claim 60, wherein the central organization and the enabling organization are a single corporate entity owned at least partly by the network of separate entities.
